(19) United States
(12) Patent Application Publication
(10) Pub. No.: US 2012/0047242 A1
(43) Pub. Date: Feb. 23, 2012

(54) INFORMATION PROCESSING APPARATUS HANDLING LICENSE FILE AND INFORMATION PROCESSING METHOD

(75) Inventors: Ryo IWASAKI, Kanagawa (JP); Yoshihiro Ogura, Kanagawa (JP)

(73) Assignee: RICOH COMPANY, LTD., Tokyo (JP)

(21) Appl. No.: 13/192,594

(22) Filed: Jul. 28, 2011

(30) Foreign Application Priority Data
Aug. 20, 2010 (JP) NO.2010-184853

(51) Int. Cl. G06F 15/16

(52) U.S. Cl. 709/223

(57) ABSTRACT

A disclosed information processing apparatus includes an installing part configured to install a function by downloading installing data of the function from outside the information processing apparatus, a license file acquiring part configured to acquire a license file for activating the function from the outside, a license managing part configured to manage existence of a license for the function regardless of existence of the license file, a license moving and updating part configured to move the license to or from another apparatus and update existence of the license of the function, a license returning part configured to cause the moved license to be returned based on an automatic return condition to a predetermined apparatus, and a license holding part configured to hold a predetermined license structure of the information processing apparatus set up by a user to cause the license to be moved in conformity with the predetermined license structure.

### BACKGROUND OF THE INVENTION

1. Field of the Invention

The present invention generally relates to an information processing apparatus handling a license file and an information processing method, and more specifically, to a management technique of a software license (right to use software) used in various apparatuses (information processing apparatuses) such as a personal computer (PC) and a copier.

2. Description of the Related Art

A license management system may be used to install software in various apparatuses including personal computers and copiers. Various apparatuses access the license management system in installing the software or acquiring a license after the installation of the software. At this time, the license is issued in exchange for information peculiar to the apparatus in which the software is installed. With this, the software can be used in the apparatuses and the license management system can prevent the software from being unfairly used in an apparatus other than the apparatus in which the software is fairly installed.

There is a case where a user wishes to move a license from an apparatus by which the license is acquired to another apparatus. Two types of license management system are ordinarily exemplified.

The first type is used when it is required to move the license from an apparatus by which the license is acquired to the other apparatus. The first type is provided to return a license from the apparatus by which the license is acquired to a license management system and software is newly introduced by installing the software and acquiring the license. The second type is used when the license is acquired from another apparatus (B) without returning the license from the apparatus (A) by which the license is acquired. The second type is provided to nullify the license of the apparatus having original license (A) by which the license is acquired in the license management system and give the license to another apparatus (C).

Patent Document 1 discloses a technique for a system which manages licenses of software installed in apparatuses in order to transfer license information of software while preventing an unfair use of the software. When an apparatus has an issued license and a request for permitting introduction of software is input from another apparatus, introduction of software to the other apparatus is permitted and use of the software with the apparatus having the issued license is prohibited from making the license information be inherited by a new apparatus (the other apparatus).
Patent Document 1: Japanese Laid-Open Patent Application No. 2006-018402

### SUMMARY OF THE INVENTION

Accordingly, embodiments of the present invention may provide a novel and useful information processing apparatus solving one or more of the problems discussed above.

More specifically, the embodiments of the present invention may provide an information processing apparatus which can easily move an introduced software license among apparatuses whose software licenses are managed by a license management system without moving the license keys and imposing burdens on users.

One aspect of the embodiments of the present invention may be to provide an information processing apparatus including an installing part configured to install a function by downloading installing data of the function from outside the information processing apparatus 1; a license file acquiring part configured to acquire a license file for activating the function from outside the information processing apparatus 1; a license managing part configured to manage existence of the license for the function regardless of existence of the license file; a license moving and updating part configured to move the license to or from another apparatus and update existence of the license of the function; a license returning part configured to cause the moved license to be returned based on an automatic return condition to a predetermined apparatus; and a license holding part configured to hold a predetermined license structure of the information processing apparatus set up by a user to cause the license to be moved in conformity with the predetermined license structure.

Additional objects and advantages of the embodiments will be set forth in part in the description which follows, and in part will be made clear from the description, or may be learned by practice of the invention. Objects and advantages of the invention will be realized and attained by means of the elements and combinations particularly pointed out in the appended claims.

### BRIEF DESCRIPTION OF THE DRAWINGS

FIG. 1A illustrates an example hardware structure of an image forming apparatus of an Embodiment.

FIG. 1B illustrates an example functional structure of the image forming apparatus of the Embodiment.

FIG. 2 illustrates example information of the license move management unit.

FIG. 3 illustrates example information of the license move management unit.

FIG. 4 is a flowchart illustrating a process example in newly installing and activating software.

FIG. 5 illustrates a processing example until a function or a license to be moved is selected from a move destination (a request source) to a move source (a request destination).

FIG. 6 is a flowchart illustrating a processing example in an apparatus of a move destination (a request source) when a license is being moved.

FIG. 7 is a flowchart for illustrating a processing example in an apparatus on a move source (a request destination) when a license is being moved.

FIG. 8A illustrates a process of setting up a license automatic return.

FIG. 8B illustrates a process of setting up the license automatic return.

FIG. 9 is a flowchart illustrating a process example of a license automatic return.

FIG. 10 is a flowchart illustrating a process example of an apparatus receiving a license automatic return.

FIG. 11A illustrates a processing example of job management unit.

FIG. 11B illustrates the processing example of the job management unit.

FIG. 11C illustrates the processing example of the job management unit.

FIG. 11D illustrates the processing example of the job management unit.

FIG. 12 illustrates a processing example of a license automatic return following information of various apparatuses.

FIG. 13 illustrates an example of original license owning state in apparatuses.

FIG. 14 illustrates example setup screen information of license structure management information.

FIG. 15 is a flowchart illustrating an example process of a license structure restoration.

FIG. 16 is a flowchart illustrating an example process of acquiring a license necessary for the restoration.

FIG. 17 is a sequence chart illustrating an example process when a license necessary for the restoration is used.

FIG. 18 is a flowchart illustrating an example process of releasing a license unnecessary for the restoration.

FIG. 19 illustrates example information to be referred to when an apparatus management unit of another apparatus is queried.

FIG. 20A illustrates an example of license structure restoration based on license structure management information.

FIG. 20B illustrates another example of the license structure restoration based on the license structure management information.

FIG. 20C illustrates another example of the license structure restoration based on the license structure management information.

FIG. 21 illustrates an example export of license structure management information to an external medium.

### DETAILED DESCRIPTION OF THE PREFERRED EMBODIMENTS

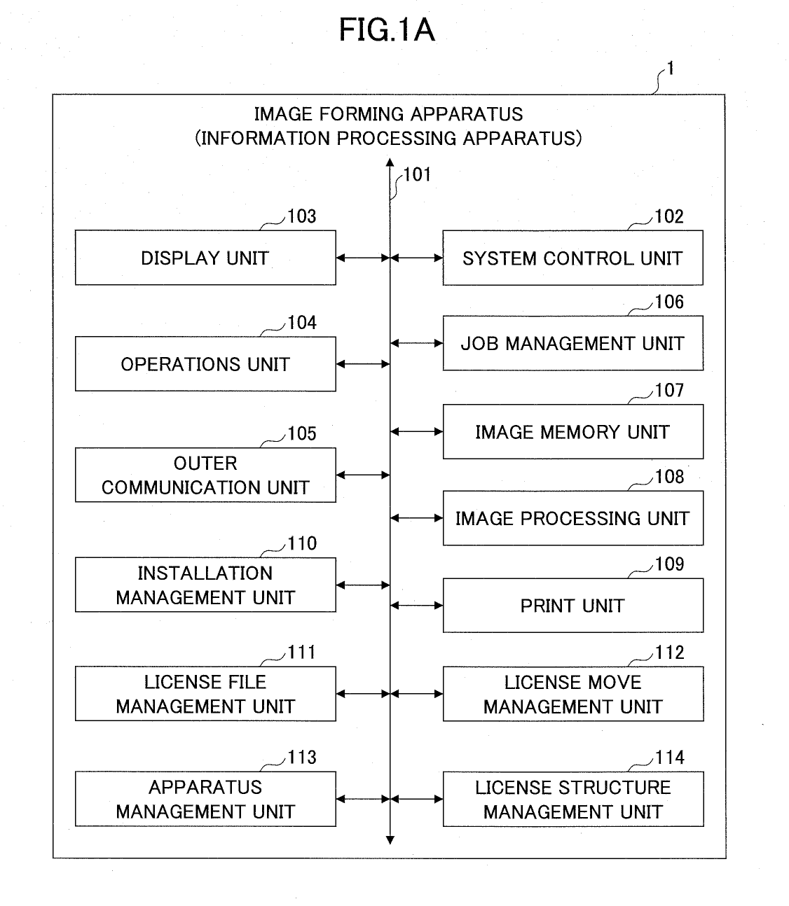

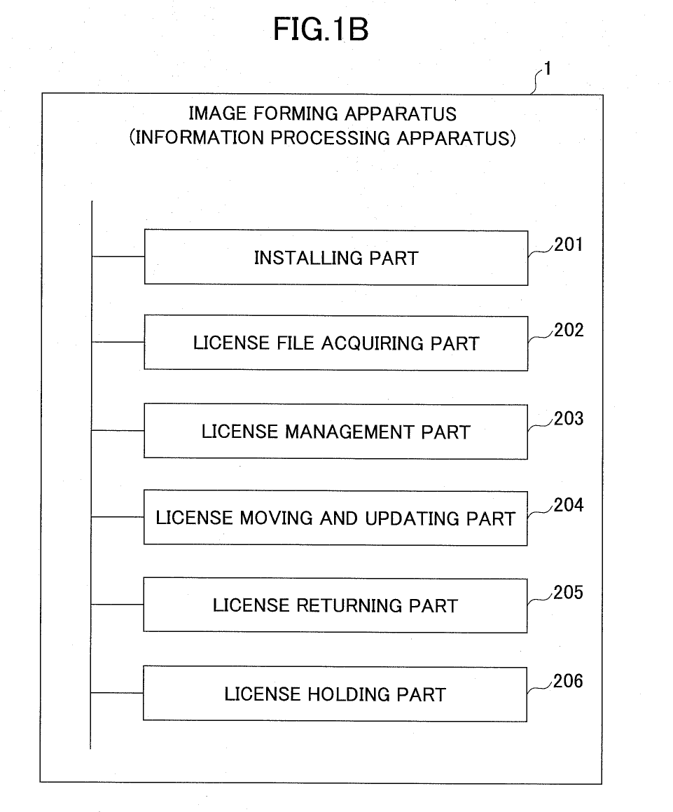

A description is given below, with reference to the FIG. 1 through FIG. 21 of embodiments of the present invention.

Reference symbols typically designate as follows:
1: image forming apparatus;
101: system bus;
102: system control unit;
103: display unit;
104: operations unit;
105: outer communication unit;
106: job management unit;
107: image memory unit;
108: image processing unit;
109: print unit;
110: installation management unit;
111: license file management unit;
112: license move management unit;
113: apparatus management unit; and
114: license structure management unit.

When the above described license management system is used, a user may input a license key of about 10 to 20 digits of alphameric characters for acquiring a license in order to prevent an unfair use or determine whether the user is authentic.

Therefore, when a license is moved from an apparatus which has acquired the license to another apparatus, a user may know the license key in any of the first and second types by remembering the license key or having license key information on hand. Because the license key is used in previously acquiring the license, an administrator of an apparatus which has acquired the license may administrate. However, the administrator may have forgotten the license key. In this case, the license key is acquired again. Even though the license key is known, if an apparatus which has acquired the license is located apart from the apparatus of the move destination, it is necessary to operate on both apparatuses. Therefore, the move of the license becomes cumbersome. In this case, it is possible to ask a third party in the vicinity of the apparatus to operate the apparatus. However, in this case, information of the license key should be given to the third party and the work becomes cumbersome.

Even if the license can be moved, there is a demand of moving the license again or returning the license to the apparatus having original license or the other apparatuses after using the function in the move destination. The demand is caused if the license and the function are not being moved for a long time, for example, a function is temporarily used for a short time while a user is visiting a work location other than an ordinary work location. However, in this case, the move of the license is cumbersome because the license should be moved again by an operation of the user.

Furthermore, the move of the license may not be considered for each function. The user may wish to construct the apparatus to have a license structure desired by the user at a predetermined timing in view of the apparatus. In this case, the license move for each function may be insufficient and licenses of necessary functions may be manually acquired by the user.

Hereinafter, embodiments of the present invention are described in detail.

### (Structure)

FIG. 1A and FIG. 1B illustrate example structures of an image forming apparatus of Embodiment 1.

Referring to FIG. 1A, an image forming apparatus 1 includes a system control unit 102, a display unit 103, an operations unit 104, an outer communication unit 105, a job management unit 106, an image memory unit 107, an image processing unit 108, a print unit 109, an installation management unit 110, a license file management unit 111, a license move management unit 112, an apparatus management unit 113 and a license structure management unit 114 connected via a system bus 101.

The system bus 101 is a path for connecting plural devices or units forming the image forming apparatus.

The system control unit 102 includes a central processing unit (CPU), deploys a program stored in a non-volatile memory onto a working area (e.g. RAM), and controls various units or the like in compliance with a program.

The display unit 103 displays various items on a screen based on display data input from the system control unit 102.

The operations unit 104 includes a keyboard having various function keys and transmits signals generated by keystroking to the system control unit 102.

The outer communication unit 105 communicates with a license management system (server) provided in the outside. Elements provided in the outside may include the license management system, a component server and a memory device such as an SD card.

The job management unit 106 carries out scheduling of jobs such as a print job. The job management unit 106 reports to the license move management unit 112 after completing the job of the corresponding function when “after using functions (after completing jobs)” in a setup of automatically returning the license after moving the license from another apparatus. The automatic return process of the license is carried out by the license move management unit 112. In a similar manner, when the corresponding function is used when the license is moved for restoring the license structure, the job management unit 106 reports to the license structure management unit 114 after completing the job of the corresponding function. The move of the license is carried out by the license move management unit 112 under a control of the license structure management unit 114.

Image data, print data or the like is stored in the image memory unit 107.

The image processing unit 108 provides input images of image editing such as image expansion, image reduction, image rotation or the like and outputs the edited image to the print unit 109.

The print unit 109 includes a photoconductive drum, toner, a paper supply unit and a paper ejection unit. The print unit 109 delivers a printing paper from a paper supply unit in compliance with a print instruction from the system control unit 102, exposes the photoconductive drum to a light for forming an image corresponding to image data input from the image processing unit 108, develops the image using the toner, fixes the toner to the printing paper by transferring the toner to the printing paper, and ejects the printing paper from the paper ejection unit.

The installation management unit 110 manages the software structural information installed in the image forming apparatus 1.

The license file management unit 111 uses the outer communication unit 105 to manage the license file downloaded from the license management system by using the outer communication unit 105 and determines whether the license is updated, whether the license is automatically returned or the like by using the license file information.

The license move management unit 112 manages the information accompanied by the move of the license file and handles various portions of the apparatuses in conformity with operations of the license. The operations of the license include query of function or license from another apparatus and control of moving or transferring the function or license. Further, automatic or manual deactivation or activation of the other apparatuses in a license move path is controlled. Further, the license move management unit 112 manages information of an automatic license return after moving the license based on a user operation and controls to automatically return the license.

The apparatus management unit 113 holds information of whether a predetermined device such as a read device, a print device and a FAX board is provided and information of performances of the apparatuses in order to respond to the other apparatuses. The information is used to determine whether the functions are usable with the apparatuses in order to determine the other apparatuses to or from which the licenses necessary for the restoration are moved.

The license structure management unit 114 holds the information of the license structure (license structure management information) set up by the user and carries out license structure restoration in conformity with the license structure management information. The license movement in the license structure restoration may be realized by directly moving between the apparatuses or by intervening with a machine (e.g., a server, and an apparatus) which manages the entire apparatus to move between the apparatuses.

Referring to FIG. 1B, the information processing apparatus 1 may include, as an example functional structure, an installing part 201 configured to install a function by downloading installing data of the function from an outside; a license file acquiring part 202 configured to acquire a license file for activating the function from outside the information processing apparatus 1; a license managing part 203 configured to manage existence of the license for the function regardless of existence of the license file; a license moving and updating part 204 configured to move the license to or from another apparatus and update existence of the license of the function; a license returning part 205 configured to cause the moved license to be returned based on an automatic return condition to a predetermined apparatus; and a license holding part 206 configured to hold a predetermined license structure of the information processing apparatus set up by a user to cause the license to be moved in conformity with the predetermined license structure.

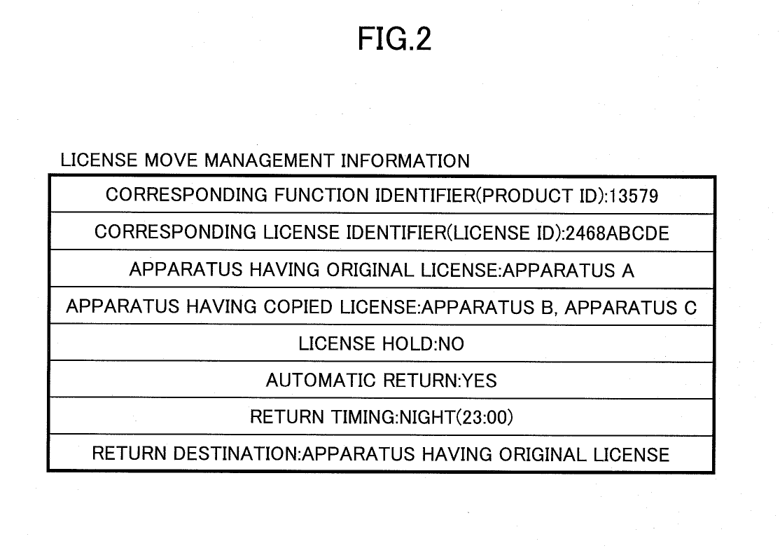

FIG. 2 illustrates an example of information held by the license move management unit 112 (i.e., the license move management information). The license move management information includes a corresponding function identifier (product ID), a corresponding license identifier (license ID), an apparatus having original license, an apparatus having copied license, a license hold, an automatic return, a return timing and a return destination. The apparatus having original license, the apparatus having copied license, the license hold, the automatic return, the return timing and the return destination are new information items originally not existing in the apparatuses.

The corresponding function identifier (product ID) is described next.

The corresponding function identifier (product ID) is used to identify the function introduced in the apparatus. There may be a user of the apparatus of the move destination (a source of operations) in moving the license between the apparatus and the other apparatus. However, the user does not always know a wanted function or license. Then, it is possible to report a movable function or license to the other apparatuses by referring to the information and acquiring the function list with the apparatus of the move destination from the other apparatuses.

The corresponding license identifier (license ID) is described next.

The apparatus acquires the license file at a time of introducing a function. The entity of the license file is held by the license file managing unit 111. The corresponding license identifier is information used to associate holding of the license (right) with the license file irrespective of the existence of the license file.

The apparatus A having an original license is described next.

The function or license is moved between the apparatuses without intervening by the license management system. After the move, depending on the license mode, an automatic license update, an automatic deactivation (license return) and a manual deactivation and succeeding activation may occur thereby causing communication between the apparatus and the license management system. However, the license management system may acquire information such as a serial number for specifying the apparatus in communicating with the corresponding apparatus. In many cases, the license management system manages the specifying information in association with the issued license. Therefore, it is not preferable to allow an access from an apparatus other than the apparatus associated with the license which is managed by the license management system at a time of accessing from all the apparatuses of which licenses are moved in or away. If the license management system manages the licenses and the apparatuses by associating the licenses with the apparatuses, the access from the apparatus other than the apparatus associated with the license which is managed by the license management system becomes an error. Meanwhile, If the license management system manages the licenses and the apparatuses without associating the licenses with the apparatuses, the operations of license for the earlier accessed apparatus are reflected and a contradiction may occur among the license management system and the apparatuses (license move paths). For avoiding the contradiction, only an apparatus that first acquires a corresponding license (hereinafter, referred to as an apparatus having original license) may be permitted to access the license management system to thereby avoid unnecessary handling for the license move in the license management system. Therefore, when the apparatus having original license accesses the license management system, there occurs no contradiction between the license and the information specifying the apparatus which may be managed by a server.

Only when the license is first acquired by an apparatus, the apparatus becomes the apparatus having original license. The other apparatuses in the license move path cannot be the apparatus having original license. Referring to FIG. 2, the apparatus having original license is not indicated by using YES or NO but it is indicated which is the apparatus having original license. When the license is manually acquired, this indication is provided to make the apparatus accessible to the license management system. Further, if the apparatus having original license is indicated by using YES or NO, the reason why the operation is not permitted (Yes or NO) cannot be known.

The apparatus A having copied license is described next. Although the function or license is moved between the apparatuses without intervening of the license management system as described above, there may exist a case where an update or deletion of the license file such as an automatic license update and an automatic deactivation (license return) may become necessary depending on the license mode. In this case, as in the above paragraph describing apparatus having original license, what communicates in the license management system is only the apparatus having original license. When the original license in the original apparatus moves to other apparatuses along the license move path, the original license is copied and the copied licenses are held by the respective apparatuses. Then, the apparatus having original license may handle update or deletion of the copied licenses in the other apparatuses along the license move path. This information of “apparatus A having copied license” may be used in order to know all the apparatuses having the copied license and existing along the license move path.

The license hold is described next. When the function or license is moved, the license file may be copied and provided to the apparatus of the move destination. Then, the number of the licenses issued by the server increases. If the increment is not properly controlled by the license management system, an unfair use may be caused. Therefore, the unfair use can be prevented if the license management system has information of whether the apparatus of the move source holds the license (the function or license is moved out by copying the license). If the information indicates NO of not holding the license, the unfair use may be controlled using the information. If the information indicates YES of holding the license, the unfair use may not occur.

The automatic return is described next.

The license movement does not always continue for a long time. There may be a case where the corresponding function is used once or for one hour like temporary rental. In this case, it is necessary to automatically return the license after using the function or after the predetermined time. Therefore, the information of automatic return is used to determine whether the license is returned to the apparatus which had held the license in the past or the license is not returned.

The return timing is described next. When it is handled that the license is automatically returned in the information of “automatic return”, the information of when the license is returned may become important. The information of when the license is returned can be selected from various time axes such as a time axis of job and a time axis of clock. The time axis of job may be “after the corresponding function is used”. The time axis of clock may be “after two hours or at night”. The information of when the license is returned is managed as “return timing”.

The return destination is described next.

When it is handled that the license is automatically returned in the information of “automatic return”, the information of to which the license is returned may become important. The information of to which the license is returned can be selected from various aspects such as information inside the apparatus and a relationship between the apparatuses. The information inside the apparatus may be the apparatus having a great frequency of using the corresponding function. The relationship between the apparatuses may be the apparatus of the move source, the apparatus having the original license, and an apparatus existing on the same floor as that of the apparatus of the move source. The information to which the license is returned is managed as return destination.

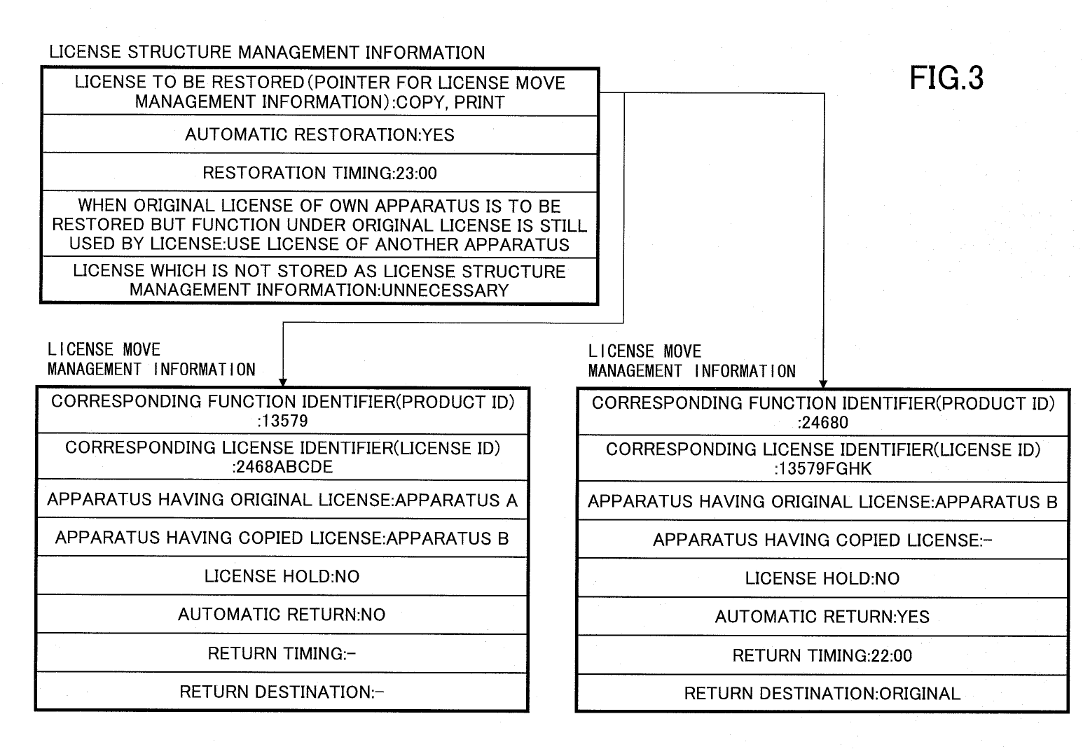

FIG. 3 illustrates an example of information (license structure management information) held by the license structure management unit 114. The license structure management information includes a license to be restored (a pointer of license move management information), automatic restoration, a restoration timing, handling when a function of a license to be restored by the apparatus having original license is being used by the other apparatus, and the license which is not stored as the license structure management information.

The license to be restored (pointer to the license move management information) is described next. The license to be restored designates functions of licenses contained in a license structure desired by a user. The license to be restored substantially becomes a pointer to the license move management information. By associating the license move management information with the license structure management information, information of the license contained in the license structure to be restored may be managed. The license move management information is as described with reference to FIG. 2.

The automatic restoration is described next. The automatic restoration is used as information for determining whether a trigger of the restoration causes the license structure to be automatically restored at a time and a timing (Yes) or the license structure is restored by a direct trigger issued by the user for the restoration (No).

The restoration timing is described next.

The restoration timing is information indicative of when a trigger for the restoration is issued. The restoration timing can be selected from various aspects such as a time and a user operation. The aspect of the time may be a clock time of “23:00”. The aspect of the user operation may be “at a time of starting up” or “power on”. The information of when the restoration is started is managed in the restoration timing.

The handling when the function of the license to be restored by the apparatus having original license is being used by the other apparatus is described next. If the original license of the own apparatus is to be restored, the original license is basically returned from the apparatus using the original license. However, if a function corresponding to the original license is being used by the apparatus, the original license cannot be immediately returned. At this time, information of whether the restoration of the corresponding license is cancelled or the license held by the other apparatus is used is managed until the original license is returned.

The license which is not stored as the license structure management information is described next.

When the license structure is restored, the license which is not contained in the license structure of the own apparatus may be held by the own apparatus. In this case, at least two kinds of handling, i.e., holding the unnecessary license in the own apparatus or moving the unnecessary information to another apparatus, can be used. The information for handling the unnecessary license is managed here.

### (License Movement)

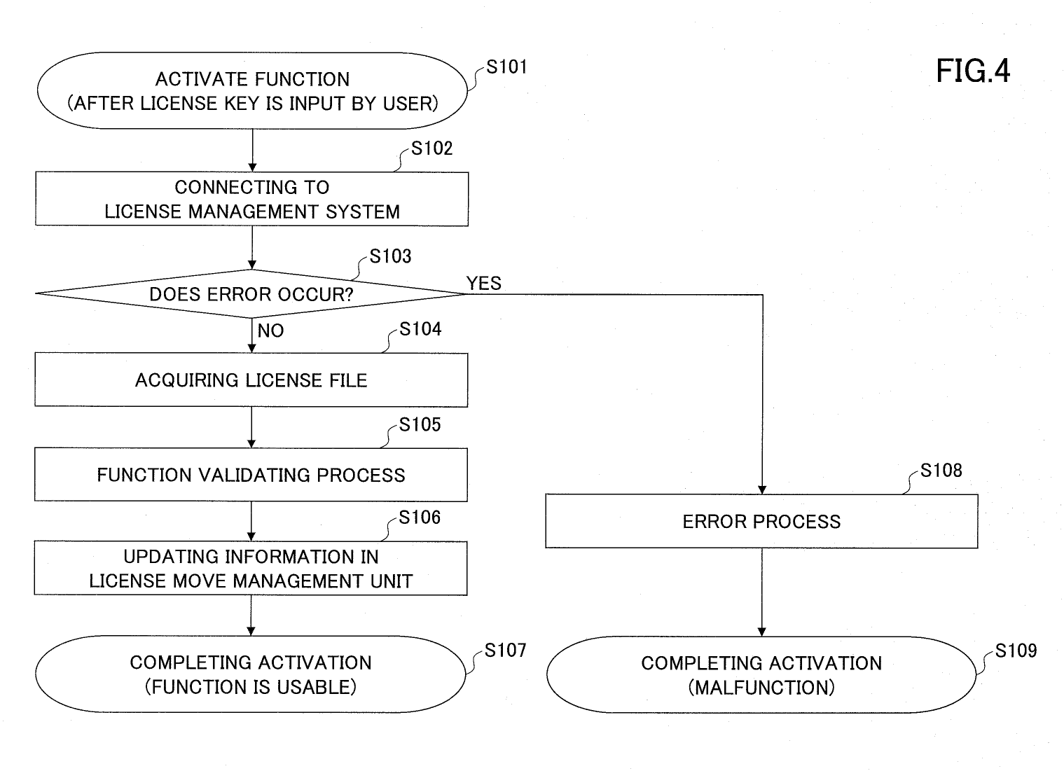

FIG. 4 is a flowchart illustrating processes in newly installing and activating software by acquiring a license for the software. The function is not validated after installing the software realizing a predetermined function without activating the software. The software can be deactivated after the software had been activated.

In step S101, a user starts to activate the software by inputting a license key on a screen of an apparatus for acquiring a license of the software in order to use a corresponding function of the software. In step S102, the apparatus is connected to a license management system to confirm whether the license key is authentic in the license management system.

In step S103, the process branches based on whether an error occurs. The error may be an connection error or a use of an illicit license key. When the error is determined, an error process is carried out in step S108. In step S109, the activation is completed as a malfunction.

When the error is not determined, the authenticity of the license key is confirmed in NO of step S102. In step S104, a license file is acquired from a license management system. The license file stores a license type, a use time limit or the like.

In step S105, a process of validating the software is carried out by using the acquired license file. The function becomes usable in response to a use time limit contained in the license file.

In step S106, information indicative of the acquisition of the license and the validation of the function according to the flow of FIG. 4 is managed in the license move management unit 112. Therefore, the ID indicative of the corresponding function, the ID indicative of the license file, the information indicating that the apparatus having original license is the own apparatus, and a license hold indicating that the license is held are set in the license move management unit 112. The copy of the license is not handled in the flow of FIG. 4 since this flow is only used to move the license. In step S107, the function becomes usable and the activation is completed.

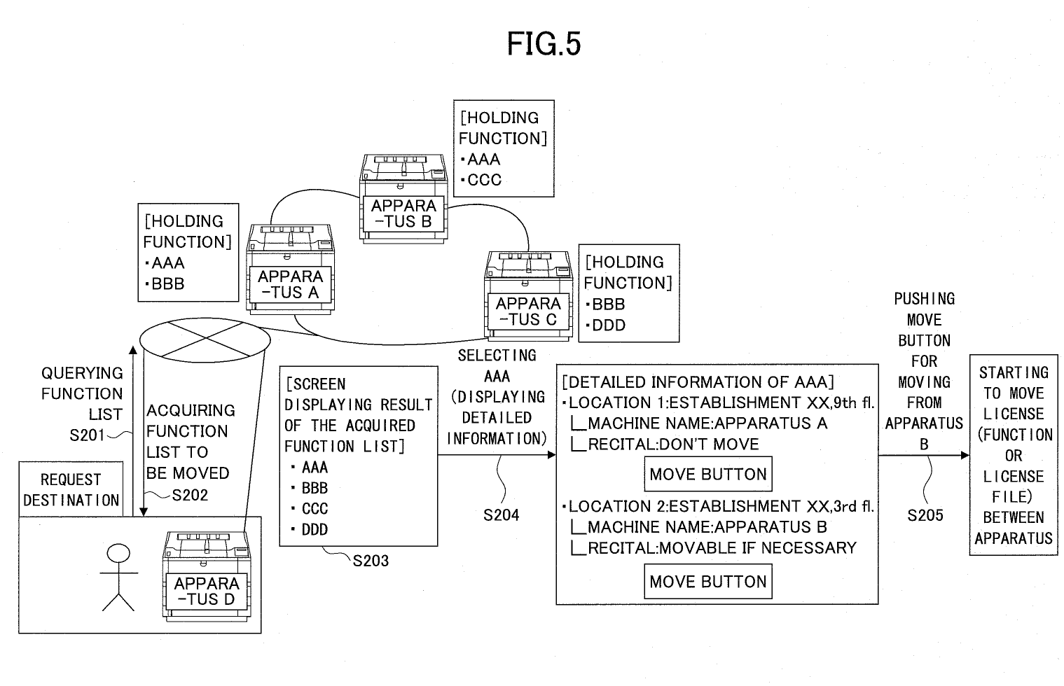

FIG. 5 illustrates a processing example until the function and the license to be moved are selected from an apparatus of a move destination (a request source) to an apparatus of a move source (a request destination).

In step S201, a function list is queried from an apparatus D of a request source to apparatuses A, B, C, . . . , connected to a network.

The queried apparatuses A, B, C, . . . return information about functions installed in the own apparatuses to the apparatus D. The apparatus D acquires the information in step S202. If the license movement does not relate to the functions, the information of the functions may not be returned. Such functions may be functions of firmware and installation and uninstallation of the software.

After receiving results of the queries from the apparatuses, the apparatus D displays a screen in step S203. If the user selects a function of interest or an aiming function in step S204, a detailed screen may be displayed. The detailed screen displays not only the information indicative of the functions, such as a function name and a function summary, but also information which can be used to determine from which the license is moved such as a location of apparatus, a frequency of using function, and a comment on a free description column. In the comment on the free description column, “do not move” may exist.

In step S205, the user may select from which apparatus at least one of a function, a license file and a license are moved and instructs the apparatus to move at least one of the function, the license file or the license.

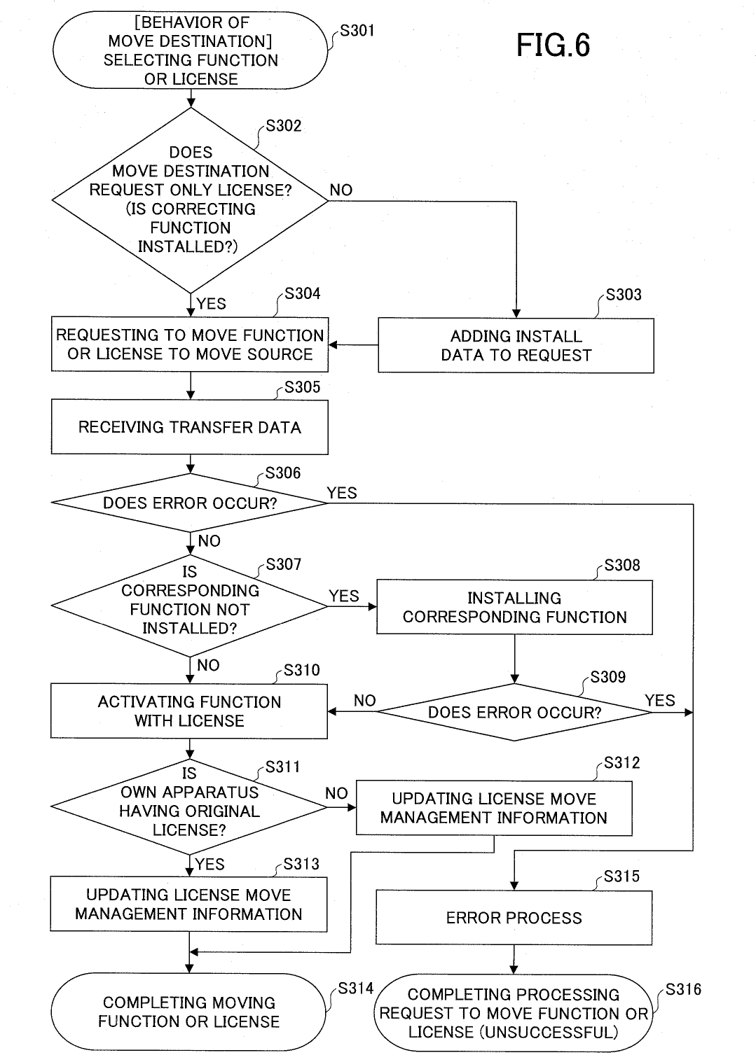

FIG. 6 is a flowchart illustrating a processing example in an apparatus of a move destination (a request source) when a license is being moved.

In step S301, the function or the license to be moved is selected. In step S302, the own apparatus checks a state of the own apparatus before sending a request for moving the function or the license to the apparatus of the request destination. When the own apparatus requests the movement of the function or the license to the apparatus of the move source, there are cases where the function has been installed and the corresponding license does not exist and where the function has not yet been installed.

If the function does not exist along NO in step S302, the request for movement of the function or the license is sent to the apparatus of the move source in S303. Install data may also be required in installing the function because the function is installed for the first time or versions of the function are differently designed.

In step S304, the movement of the function or the license is requested. If the installing data are required in step S303, the own apparatus requests to send the installing data.

In step S305, transfer data based on the corresponding license of the function are received.

In step S306, it is determined whether an error exists in receiving the transfer data. If there is no error in step S306, it is determined whether the function has not been installed yet in step S307.

If the function has not yet been installed and the function is requested to be transferred, in step S308, the function is installed using the received installing data of the function. If the installing data are required because of a difference in the versions, an update process may be internally carried out. If no error has occurred in step S309, the process goes to a process carried out when the function has not been installed.

In step S310, the license file is used to activate (validate) the function. Since the function or the license is moved between the apparatuses in a similar manner to the process in the apparatus of the move source, the apparatus of the move destination does not communicate with the license management system.

In step S311, it is determined whether the own apparatus is an apparatus having an original license. If the own apparatus is not the apparatus having the original license, license move management information is updated by the license move management unit 112 in step S312. Specifically, the “license hold” (see FIG. 2) of the license move management information is updated to indicate the license is held. The “apparatus having original license” (see FIG. 2) of the license move management information is updated to indicate the apparatus having the original license. The “apparatus having copied license” (see FIG. 2) of the license move management information is blank since an apparatus other than the apparatus having original license is not used.

The apparatus having the original license could have used the function when the function has been activated based on an external system and may invalidate the license of the own apparatus to move the license if the license of the function is requested to move with another apparatus. However, even if the license is moved from the own apparatus to the other apparatus requesting to move the license, the license may be restored from the other apparatus to the own apparatus.

If the own apparatus is the apparatus having original license, the license move management information can be updated by the license move management unit 112 in step S313. Specifically, the “license hold” (see FIG. 2) of the license move management information is updated to indicate the license is held. The “apparatus having original license” (see FIG. 2) of the license move management information is not updated because the own apparatus is the apparatus having the original license. The “apparatus having copied license” (see FIG. 2) of the license move management information is not updated since the apparatus having a copied license is not used. With this, in step S314, the movement of the function or the license is handled.

Meanwhile, if there is an error in receiving the transfer data, in analyzing the received transfer data or in installing the transfer data, the data transfer is again requested in the error process in step S315 or a failure of the license movement is determined in step S316. Further, if the transfer data has no error in analyzing the received transfer data and there is an error in installing the transfer data or in activating the transfer data, a recovery operation is carried out to enable the own apparatus to use the function. However, if the error still exists after the recovery, the function cannot be used after the recovery. Then, the license may be returned to the apparatus of the move source, and the processes in the own apparatus and the apparatus of the move source are rolled back to avoid contradiction of information handled in the license move management units.

In the above described flow, the installing data and the data of the license file are transferred when necessary. However, if the license is moved many times between the apparatuses, there may be caused a state in which the apparatuses respectively have installed functions and the license files. In this case, the apparatus of the request destination is requested to move only the license for the function. The received data become only information used to move the license such as the apparatus having the original license and a deadline for validation in the apparatus having the original license (not a deadline for validation of the license file).

The information of the apparatus having the copied license is not necessary as the receiving data for the apparatus of the request destination because the information of the apparatus having the copied license is sent to the apparatus having the original license when the license is moved from an apparatus other than the apparatus having the original license to the other apparatus. Further, it is not necessary to send the information of license hold since the license is actually held by the apparatus having the original license. However, it may become necessary to send the information if the information is fit together between the apparatuses for rolling back the processes.

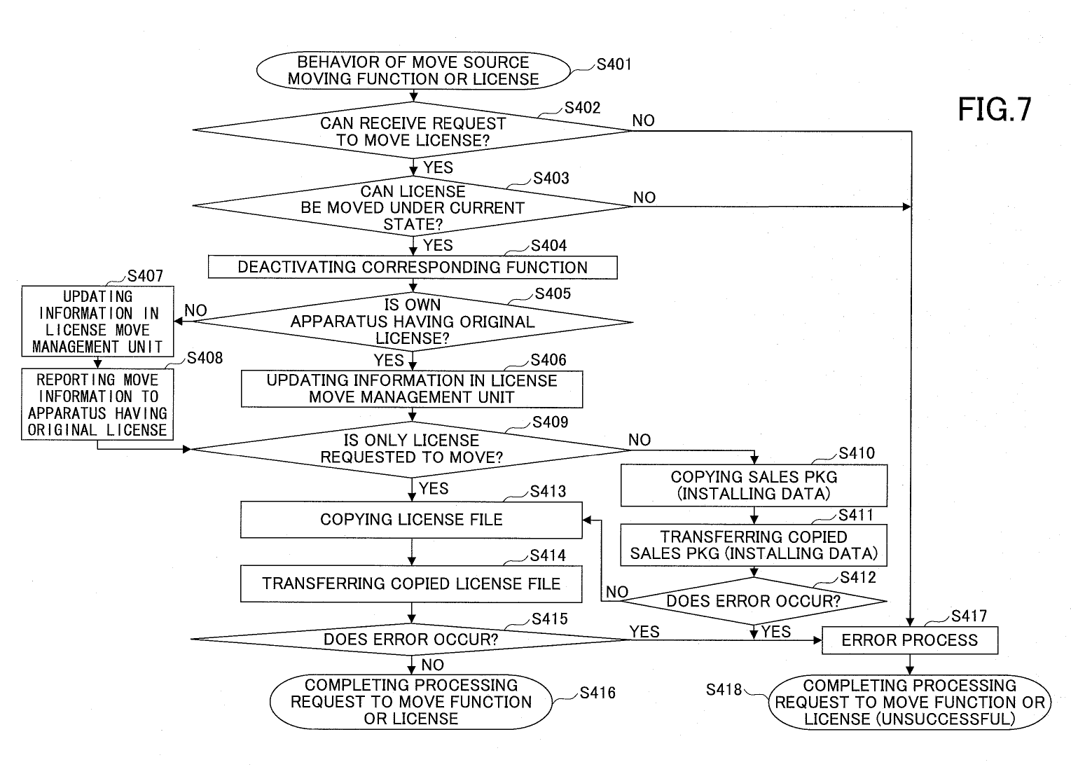

FIG. 7 is a flowchart for illustrating a processing example in the apparatus on the move source (the request destination) when the license is being moved.

In step S401, the function or the license is requested to be moved in step S401. In step S402, it is determined whether the license movement can be received or not. This is because even though the license file has already been existing and the license has been once held, the license may have been moved to the other apparatus. In this case, the license cannot be moved. Therefore, it is determined in advance whether the request for moving the license can be received.

If the request for moving the license can be received in YES of step 402, it is determined whether the function and the license can be moved. When the function corresponding to the requested license is running, waiting for the run, or being reserved, the function or the license of the apparatus cannot be moved.

If the license can be moved in YES of step S403, the function cannot be used, and the corresponding function is deactivated in step S404. In the ordinary deactivating process, the license is returned to the license management system. However, when the function or the license is moved, the movement of the function or the license is realized between the apparatuses. Therefore, the license is not returned to the license management system. Here, the license is not returned and a process of invalidating the function corresponding to the license is carried out.

In step S405, it is confirmed whether the own apparatus is the apparatus having original license with reference to the information in the license move management unit 112.

If the own apparatus is the apparatus having the original license in YES of step S405, the license move management unit 112 adds the information of the move destination to the information of the apparatus having the copied license by the license move management unit of the own apparatus in step S406. Further, the information of license hold is updated to “the license is not held”.

If the own apparatus is not the apparatus having the original license in NO of step S405, the license move management information can be updated by the license move management unit 112 to be “the license is not held” in step S407. At this time, the information of the apparatus having the copied license is not handled because the own apparatus is not the apparatus having the original license.

In step S408, the information indicative of the license being moved to the other apparatus is reported to the apparatus having the original license. The apparatus having the original license reported as such adds the information of the reported apparatus to the information of the apparatus having the copied license by the license move management unit 112 of the apparatus having the original license.

In step S409, it is determined whether only the license file is to be moved or the install data of the function is also required to be moved. This determination in step S409 is based on the request in step S401.

If the installing data of the function are also moved in NO of step S409, the installing data of the function is copied in step S410. The installing data may be data of a sales package (PKG) in a releasing form.

In step S411, the copied installing data is transferred to the apparatus of the request source. If there is no error in transferring the installing data in step S412, the process flows together with the process of moving only the license in NO of step S412.

In step S413, the license file corresponding to the function is copied.

In step S414, the copied license file is transferred to the apparatus of the request source. As to the copy or transfer of the license file, the number of times (e.g., 10 times) of copying or transferring the license file may be limited. The location of the apparatus of the request source may be limited to, for example, the same floor as that of the own apparatus. In this case, floor installation information may also be required to be updated by the license move management unit.

If the error is not determined in NO of step S415, the movement of the function or the license is completed in step S416.

In step S417, it is reported the apparatus of the request source that the request cannot be accepted with No of step S402 or NO of step S403. However, in the case of the error occurs in transferring the data, the information of the license move management unit 112 has been updated. Therefore, the process is rolled back to the state before the update. After the error process, the request to move the function or the license is completed as unsuccessful (NG).

When the process is rolled back with the error in the data transfer, the roll-back in the own apparatus is reported from the own apparatus to the apparatus of the request source to prompt the apparatus of the request source to roll back the process in order to avoid contradiction between the own apparatus and the apparatus of the request source.

If a communication line is disconnected and the above report cannot be sent to the apparatus of the request source, retry processes may be repeated. If the report is resultantly unsuccessful, the license of the function may be temporarily invalidated in order to avoid the contradiction between the own apparatus and the apparatus of the request source. In this case, the reason for the temporary invalidation of the license is reported to users by means of a screen or an e-mail and the roll-back is prompted to restore the system. Thereafter, if fitting between the own apparatus and the apparatus of the request source is secured as the result of the report, the invalidation is cancelled. Thus, the processes of the apparatuses are rolled back to states of before the movement request of the function or the license. Data partly received and not completed are disposed of in rolling back the process of the apparatus of the request source.

In the above described flow, the installing data and the data of the license file are transferred when necessary. However, if the license is moved many times between the apparatuses, there may be caused a state in which the apparatuses respectively have installed functions and the license files. In this case, the apparatus of the request destination is requested to move only the license for the function. The transfer data become only information used to move the license such as the apparatus having the original license and a deadline for validation in the apparatus having the original license (not a deadline for validation of the license file). If the deadline for validation of the license file is for example +3 months, the deadline for validation extends more as the movements are repeated. However, it is necessary to follow the deadline for validation of the original license file first validated by the apparatus having the original license. Therefore, the deadline for validation of the apparatus having the original license (the request destination) is applied.

The information of the apparatus having the copied license is not required to be reported to the apparatus of the move destination because the information of the apparatus having the copied license is sent to the apparatus having the original license when the license is moved from an apparatus other than the apparatus having the original license to the other apparatus. Further, it is not necessary to send the information of license hold since the license is not held by the apparatus having the original license at the time of moving the license. However, it may become necessary to send as the information if the information is fit together between the apparatuses for rolling back the processes.

(Automatic License Return after Moving the License)

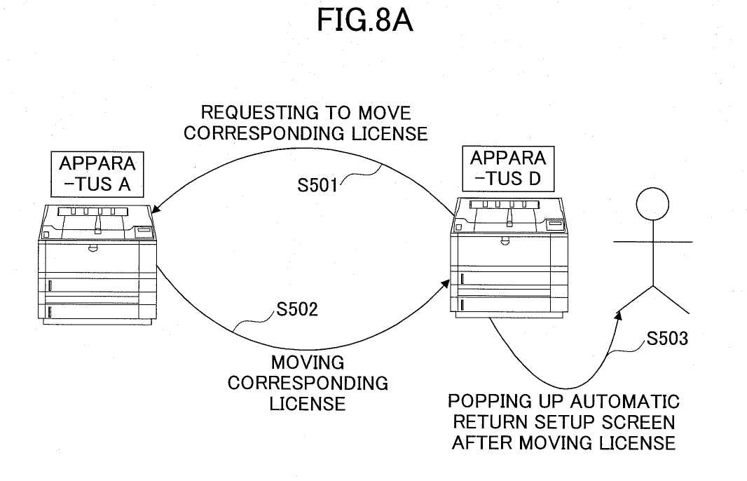

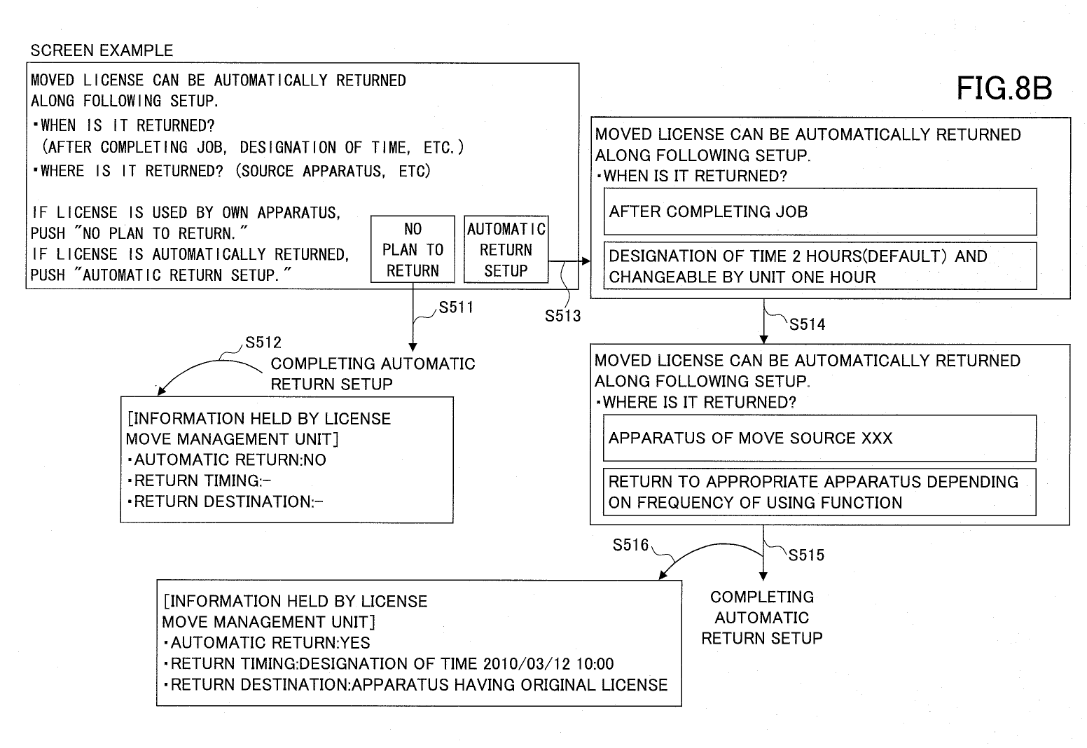

FIG. 8A illustrates a process of setting up a license automatic return. FIG. 8B illustrates a process of setting up the license automatic return.

Referring to FIG. 8A, in step S501, the license is requested to be moved from an apparatus D to an apparatus A. In step S502, the license is moved from the apparatus D to the apparatus A. In step S503, an automatic return setup screen is displayed as a popup screen by the license move management unit 112 in the apparatus D on the license move requesting side. An example in which an input is prompted using the pop-up setup screen immediately after moving the license is described. However, the embodiment is not limited to the example. The pop-up setup screen can be displayed any time and the input can be revised any time.

Referring to FIG. 8B, “NO PLAN TO RETURN” or “AUTOMATIC RETURN SETUP” is selected by the user because the need of the automatic return setup changes depending on whether a long term movement of the license is required or a short term movement of the license is required to temporarily use the function. If the “NO PLAN TO RETURN” is selected in step S511, the information of automatic return (see FIG. 2) of the license move management information is set to be “No” indicative of no automatic return by the license move management unit 112 in step S512. The update of the license move management information is thus completed.

If the “AUTOMATIC RETURN SETUP” is selected in step S513, two aspects (of a time and a place) of when and where the license is returned are input.

As to the time, “AFTER COMPLETING JOB” is selectable because the license may be returned after completing use of the job in a case of temporarily using the function. It is possible to carry out an automatic return process immediately after completing a job using the function. However, continuous jobs using the function may be considered. Therefore, when the jobs are continuously input, a message of “Please press N if jobs are continuously input, and please press Y if a job is finally input and the license is returned after the completion” may be displayed.

Meanwhile, it is possible to make the timing of returning the license be designated by a year, month, day, hour, minute and second. For relaxing a burden on the user, default such as “today, night 22:00”, “after one day” and “after one week” may be displayed for easy setup.

After the time is selected in step S514, the place is set as the return destination. The place may be “APPARATUS OF MOVE SOURCE” indicative of the apparatus having the original license in the license move management information or “APPARATUS OF MOVE SOURCE” indicative of the apparatus from which the license is moved. The selection of “APPARATUS OF MOVE SOURCE” becomes available by adding this information to the license move management information.

Said differently, the apparatus having the original license is specified in the license move management information by the license move management unit 112. Therefore, when the “APPARATUS OF MOVE SOURCE” is selected in the license automatic return setup, the license may be returned to the apparatus having the original license which had originally held the license. The “APPARATUS OF MOVE SOURCE” may also be, instead of the apparatus having the original license, an apparatus of the move source to which the original license had been moved from the apparatus having the original license before the original license is further moved to the own apparatus. In this case, by newly adding the information of “APPARATUS OF MOVE SOURCE” to the license move management information to enable the selection of the “APPARATUS OF MOVE SOURCE”, the license may be returned to the apparatus of the move source. In the information of “APPARATUS HAVING COPIED LICENSE” (see FIG. 2), the information of the license move path is held. However, the information of the license move path is solely held by the apparatus having the original license. Therefore, the information of “APPARATUS OF MOVE SOURCE” needs to be added to the apparatus D illustrated in FIG. 8A. The information is used to know the apparatus in the license move path because the apparatus having the original license needs to trigger processes such as the automatic license update and is used to exchange the information between the apparatus to which the license is moved and the apparatus having the original license.

Besides the determination of the place (the return destination) of the license using the license move management information, the place (the return destination) may be selected from the apparatuses with reference to the information of the apparatuses. For example, it is possible to select the place further from “RETURN TO APPROPRIATE APPARATUS DEPENDING ON FREQUENCY OF USING FUNCTION”. In addition to the selection of “RETURN TO APPROPRIATE APPARATUS DEPENDING ON FREQUENCY OF USING FUNCTION”, the selections may further include “RETURN TO APPROPRIATE APPARATUS DEPENDING ON THE NUMBER OF REGISTERED USERS”, “RETURN TO APPROPRIATE APPARATUS DEPENDING ON FREQUENCY OF USING CORRESPONDING FUNCTION” and “RETURN TO APPROPRIATE APPARATUS DEPENDING ON ITS LOCATION”.

“RETURN TO APPROPRIATE APPARATUS DEPENDING ON THE NUMBER OF REGISTERED USERS” is provided because the use of the apparatus becomes more frequent as the number of the users increases. “RETURN TO APPROPRIATE APPARATUS DEPENDING ON FREQUENCY OF USING CORRESPONDING FUNCTION” is provided because the use of the apparatus becomes more frequent as the frequency of using the corresponding function increases. The frequency of using the corresponding function may be a counter value of the corresponding function. This selection is provided because even if the number of registered users is great, when the corresponding function is not used by a great number of the registered users, the number has less influence on the return destination.

“RETURN TO APPROPRIATE APPARATUS DEPENDING ON ITS LOCATION” is provided for convenience. Recital information of the location needs to be input in an initial setting for the apparatus. If the apparatus of the return destination is determined as the apparatus of the move source, the apparatus of the move source may already restore the license of the same function from the other apparatus. In this case, the license need not be returned and may be moved to another apparatus located on the same floor as that of the apparatus of the move source. The reason why the same floor is considered is that in an area around the apparatus in which a certain function is used, the same function may be positively used. The frequency of using the corresponding function may also include being used by apparatuses in the same area such as the same floor.

By selecting the place in step S515, the license move management information is set as in step S516. If the time is selected as “AFTER COMPLETING JOB”, the license move management unit 112 reports the selection to the job management unit 106, and the job management unit 106 monitors the completion of the corresponding job. The operation in the job management unit 106 is described in detail later.

When the apparatus of the return destination is not known by the apparatus having the original license, the apparatus of the move destination may be reported to the apparatus having the original license. The apparatus of the move source provides the information of the apparatus of the move destination to the apparatus having the original license in order to let the apparatus having the original license know the license move path and the apparatus having a copied license for the license automatic update or the like. Depending on setting of the automatic return, the apparatus of the move destination may not be known by the apparatus having the original license. Therefore, it is necessary to let the apparatus having the original license know the apparatus of the move destination. The report may be sent from the apparatus of the return destination or the apparatus of the return source. The license move management units 112 of the apparatus of the return source and the apparatus of the return destination gives and receives the information of the apparatus having the original license. In order to know whether the information of the apparatus having the copied license known by the apparatus having the original license includes the apparatus to which the automatic return is carried out, one of the apparatus of the return source and the apparatus of the return destination needs to report the apparatus of the move destination to the apparatus having the original license.

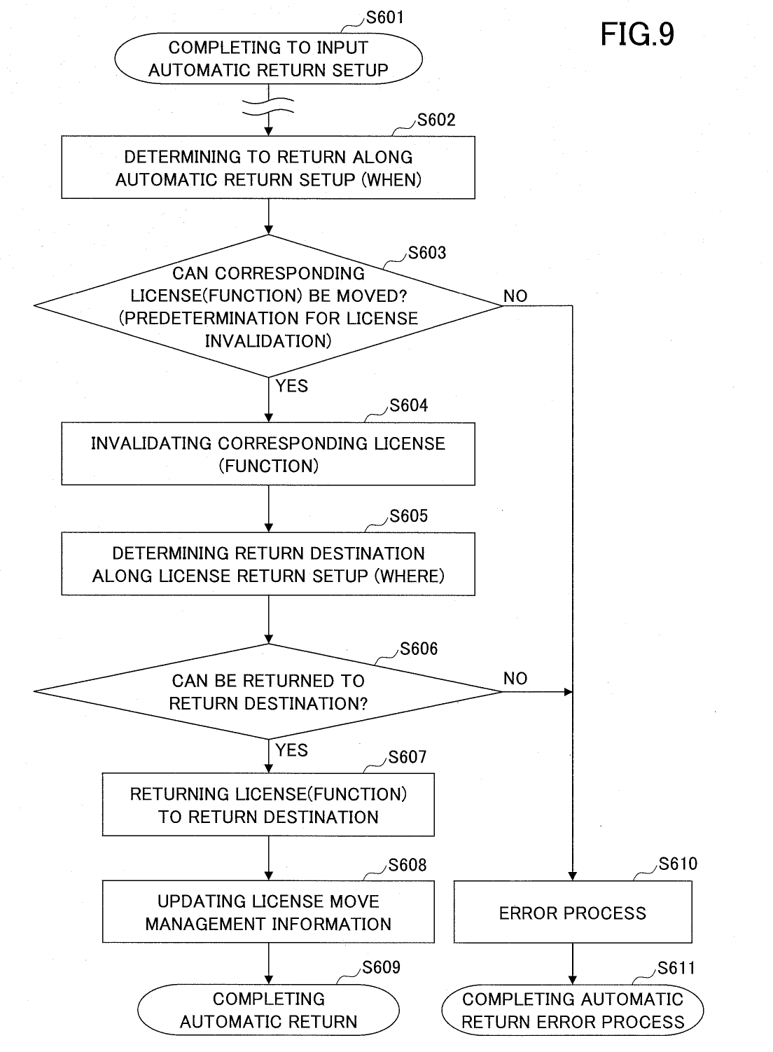

FIG. 9 is a flowchart illustrating a process example of a license automatic return.

Referring to FIG. 9, the automatic return setup is completed in step S601. In step S602, the automatic return process is carried out in accordance with the time of the automatic return setup. If the automatic return setup is “AFTER COMPLETING JOB”, the job management unit 106 recognizes the completion of the corresponding job. After the recognition of the completion of the corresponding job, the job management unit 106 reports the completion to the license move management unit 112 to determine that the automatic return process is carried out. If the automatic return setup is based on the time, the license move management unit 112 compares the time with the current time. When the time matches the current time, the automatic return process is carried out.

In step S603, it is determined whether the corresponding license of the function can be moved. It is necessary to invalidate the license in step S604 before returning the license. However, if moving the corresponding license is being carried out, the invalidation cannot be carried out. Therefore, a predetermination is done.

If the license (function) cannot be moved, an error process is carried out in step S610. While the corresponding function is being carried out, the completion of the function may be a waited or the invalidating process may be retried a predetermined number of times. If the corresponding function is carried out yet or without carrying out the error process in step S610, the license automatic return may be ended in step S611.

If the corresponding license is moveable, the corresponding license (function) is invalidated as a preparation for the return process in step S604. However, if the corresponding license (function) has been already invalidated, the step S604 is skipped.

In step S605, in conformity with the time of the automatic return process, the apparatus of the return destination is determined. A request of returning to the apparatus of the return destination is sent to the apparatus of the return destination to check a state of the apparatus of the return destination. If the function of the apparatus of the return destination has already been deleted, a license file, installing data, the license move management information including the apparatus having the original license and the deadline for validation are transferred.

If the return destination is powered off or cannot be communicated with, NO is selected in step S606. Then, the retry process is carried out in conformity with the predetermined number of times in the error process in step S610. However, if the communication cannot be maintained, the automatic return error is completed.

During the automatic return, if the apparatus of the return destination has already had the license returned by purchasing the license or moving from another apparatus or the apparatus of the return destination is powered off or causes a communication error, it is possible to change the apparatus of the return destination. Said differently, the license may be moved for a short term when the automatic return is set. However, if the license is not returned to the selected return destination, the license is not continued to be held and returned to an appropriate apparatus. The default preference order of returning to the apparatus of the return destination is for example:

(1) User setup (A setup selected by a user)

(2) Apparatus having original license

(3) Move source

(4) Location

(5) Frequency of using function

(6) Number of registered users

A predetermined preference order can be changed.

If the license cannot be returned to any one of the apparatuses in the preference order under the automatic return (e.g., the license is already held by purchasing the license, the apparatuses are powered off, and the apparatuses have already been removed), the automatic return is ceased and the license of the own apparatus is validated again.

If the automatic return was unsuccessful at the set automatic return timing because of the power off of the own apparatus, the automatic return is carried out after restarting the own apparatus. In the case of the automatic return timing is “DESIGNATION OF TIME” (see FIG. 8), the license is automatically returned after the restart of the own machine. Because it is difficult to determine that all the jobs are completed before the power-off, the restarted own apparatus needs to wait for a job input and receive a report of completing the input of the jobs and ready for the license movement.

Meanwhile, if the corresponding job is received and cannot be invalidated before the automatic return process at the automatic return timing, the input job is processed and then the invalidation of the function is retried a predetermined number of times. Here, one type of the job is based on a designation of time. In the job based on a designation of time, if the designation of time is earlier than the automatic return timing, the automatic return is deemed to be NG (no good) and not admitted. With this, it is possible to prevent the obstruction of the corresponding job by the return of the license at the designated time.

In step S607, necessary data are transferred as the automatic return process to the apparatus of the return destination. Depending on the state of the apparatus of the return destination, the data are changed as described in step S605.

In step S608, after completing the communication with the apparatus of the return destination, the license move management information is updated by the license move management unit 112. The information of “LICENSE HOLD” (see FIG. 2) is changed from YES to NO, and after completing the return the automatic return setup is initialized.

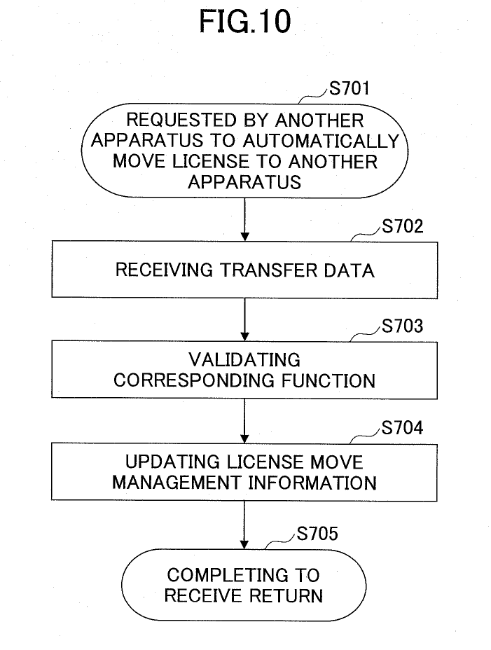

FIG. 10 is a flowchart illustrating a process example of the apparatus receiving the license automatic return.

Referring to FIG. 10, the license automatic return is received in step S701. Because the data type to be exchanged is different depending on the structure of the apparatus (the state of the license to be returned), the structure of the own apparatus is reported to the apparatus of the request source. If the corresponding function has already been deleted in the own apparatus, it is reported that the corresponding data are deleted to the apparatus of the request source. Then, it is necessary to receive the license file, installing data and license move management information which are transferred from the apparatus of the request source and install these to validate the corresponding function.

In step S702, only the data necessary for the structure of the own apparatus are transferred and received by the own apparatus.

In step S703, the function is validated by the corresponding license based on the received data.

In step S704, the license move management information is updated. For example, the information of “LICENSE HOLD” (see FIG. 2) is updated from NO to YES. After this, the process is completed.

The detailed process including the error process is similar to that illustrated in FIG. 6 and FIG. 7.

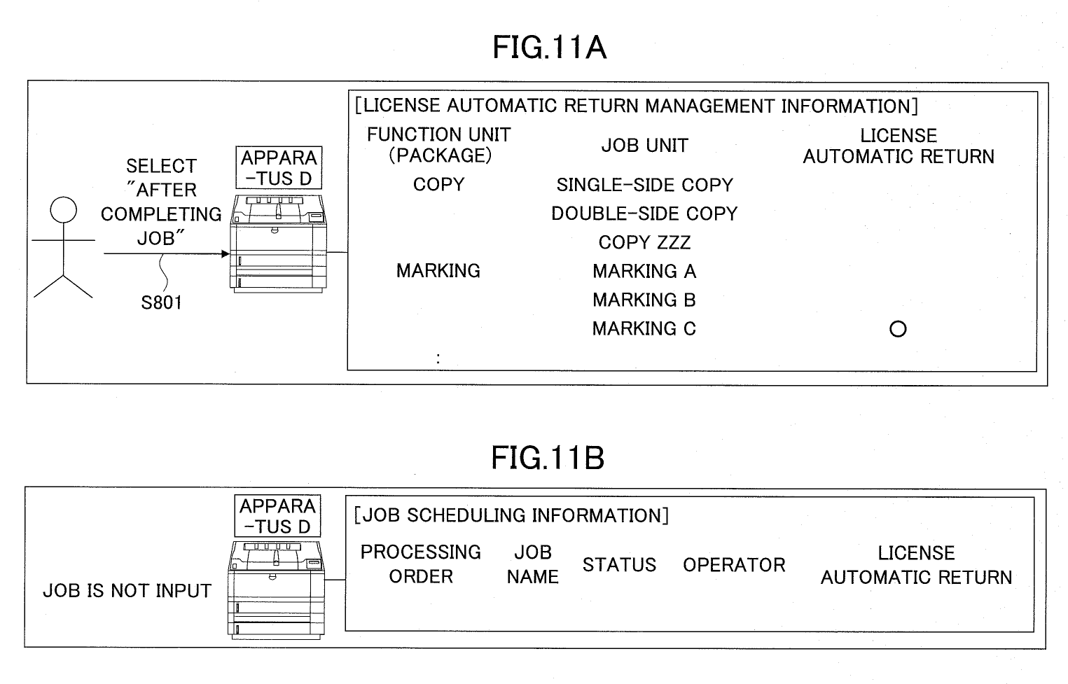

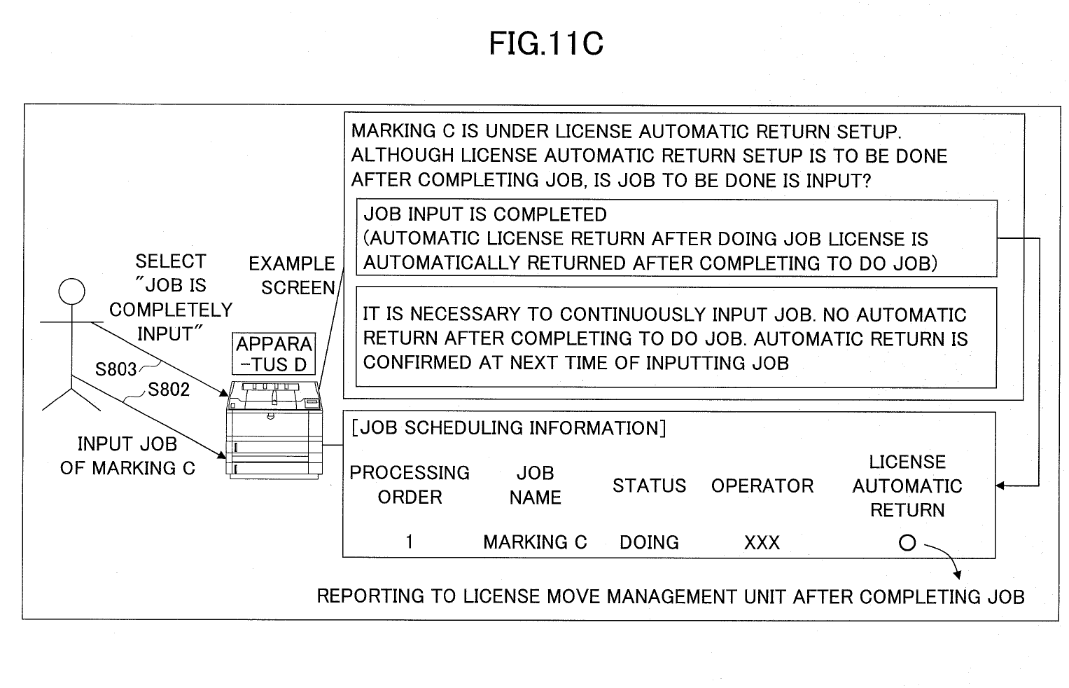

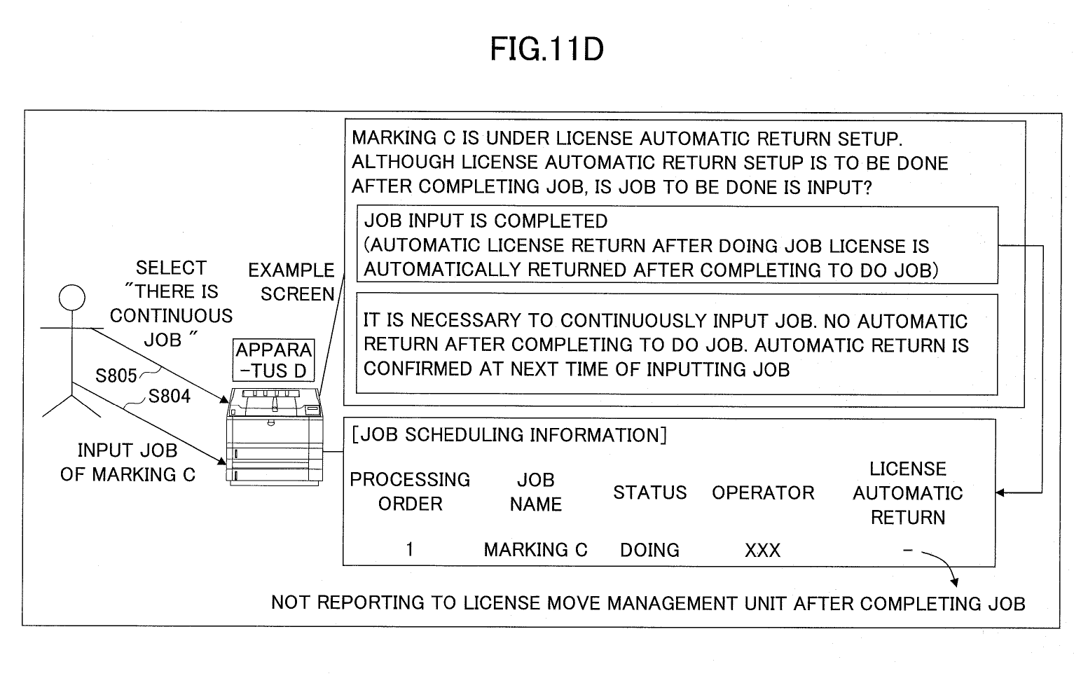

FIG. 11A to FIG. 11D illustrate example processes with the job management unit 106 when “AFTER COMPLETING JOB” (see FIG. 8B) is selected as the time of the automatic return setup.

Referring to FIG. 11A, if the user selects “AFTER COMPLETING JOB” after step S514 (see FIG. 8B) in step S801, the license move management unit 112 of the apparatus D requests the job management unit 106 to report the completion of the job to the license move management unit 112 after the corresponding job is completed, and the job management unit 106 sets up a license automatic return flag “o” in a job unit corresponding to the function as license automatic return management information. Referring to FIG. 11A, the license automatic return flag “o” is set to a job unit of “marking C” in a function unit (i.e., a package) of “MARKING”.

If the job with the license automatic return flag is completed, the job management unit 106 reports the completion to the license move management unit 112. In order to recognize the job completion, the license moved by the license move management unit 112 and the corresponding function (e.g., the package) are associated using the license automatic return management information. Without managing in the job management unit 106, if a portion managing the apparatus structure such as the installation management unit 110 manages information of a sales package to be introduced by a predetermined function or a user as installing information, the job management unit 106 may refer to the installing information to associate the license moved by the license move management unit 112 with the corresponding function (e.g., the package).

FIG. 11B illustrates job scheduling information in a case where the job is not input in the apparatus D.

Referring to FIG. 11C, if a job of “MARKING C” is input by the user in step S802, it is confirmed whether the job is input in a screen of the apparatus D. If the user selects “JOB IS COMPLETELY INPUT” in step S803 (when the job input is completed, the user pushes “JOB INPUT IS COMPLETED”), the job is input and the job of “MARKING C” is added to the job scheduling information (FIG. 11C). For the input job of “MARKING C” in the license automatic return management information, the license automatic return needs to be validated for returning after the completion of the job. Therefore, a flag of “LICENSE AUTOMATIC RETURN” in the job scheduling information is marked by “o”.

Thereafter, the input job of “MARKING C” is carried out. When the job management unit 106 recognizes the completion of the job after the job of “MARKING C” is carried out, the job management unit 106 reports identification of the license (a sales package) corresponding to the job to report the completion of the job and a need for the automatic return to the license move management unit 112. It is possible to specify the user who has done the license automatic return setup to prevent the automatic return in a job carried out by a user other than the user who did the license automatic return setup. This is realized by making the user determine the association between the job and the function (a sales package) with the license move management unit 112. In response to this, the license move management unit 112 automatically returns the license.

Referring to FIG. 11D, if the user inputs the job of “MARKING C” in step S804 and another job is planned to be input continuously or with an interval of time, a button of “THERE IS CONTINUOUS JOB” is selected by the user in step S805. In this case, because the license need not be returned after completing the job, the flag of “LICENSE AUTOMATIC RETURN” is not validated. Therefore, it is unnecessary to report that the job is completed, and that the license automatic return is necessary is not reported to the license move management unit 112 when the job management unit 106 recognizes the completion of the job.

When a mechanism of setting a predetermined term is provided and the corresponding job is not input after a lapse of the term, the automatic return process is carried out in conformity with the setup of the automatic return. This is provided to prevent the license from being not returned by waiting for the completion of the job.

It is possible to prevent the automatic movement of the license if the cancellation of the job is received while the flag of “LICENSE AUTOMATIC RETURN” is marked after inputting all the jobs. The flag of “LICENSE AUTOMATIC RETURN” is marked by the job management unit 106 when the job management unit 106 knows the completion of the job input from a user's operation. However, when the job is cancelled, the flag is ignored when the job is cancelled and the license is not moved. This is because the job is not always cancelled by the user who inputs the job.

In the above, the license corresponding to each job has been described. However, it is possible to automatically return the license (a sales package) moved from the other apparatuses irrespective of the jobs. Said differently, the jobs are parts of functions provided by a sales package. Licenses corresponding to the jobs, the function and the sales package can be returned.

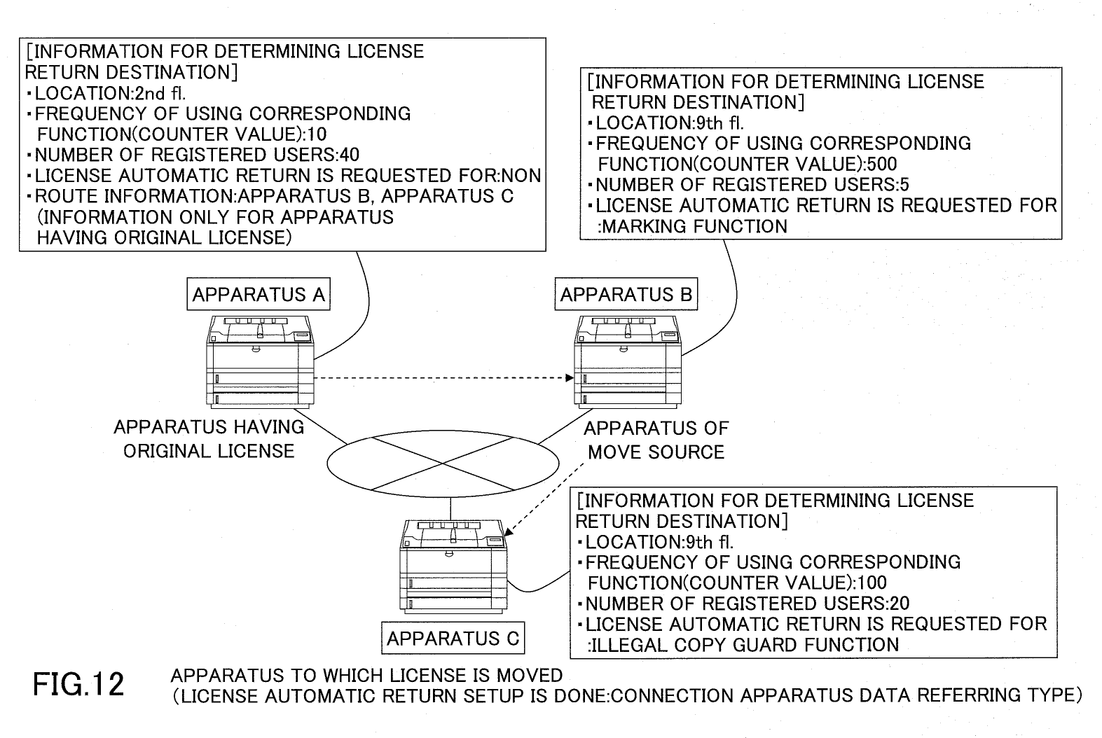

FIG. 12 illustrates a processing example of a license automatic return following information of various apparatuses. Referring to FIG. 12, the apparatus A purchases a function from a license management system (a server) to be an apparatus having an original license. An apparatus B receives the function from the apparatus A. An apparatus C receives the function from the apparatus B.

It is possible to extract information of apparatuses connected by a network in addition to a license move path as an automatic return destination and make the suitable apparatus be a move destination. In this case, after step S514 of FIG. 8B, instead of the license move path, a return destination is set based on a reference of the apparatus information such as “RETURN TO APPROPRIATE APPARATUS DEPENDING ON FREQUENCY OF USING FUNCTION”.

Referring to FIG. 12, the apparatuses have information such as LOCATION, FREQUENCY OF USING CORRESPONDING FUNCTION (COUNTER VALUE), NUMBER OF REGISTERED USERS, LICENSE AUTOMATIC RETURN or the like. Information for determining the return destination is not limited thereto.

As to LOCATION, before the license is returned from the apparatus C to the apparatus A (a setup of returning to the apparatus having the original license) and the license still exists in the apparatus C, the apparatus A may purchase a new license for the same function as the license to be returned or get a license for the same function from another apparatus. Said differently, when the license is returned to the apparatus A, the license may become already unnecessary before the license is returned to the apparatus A. Because it is possible to return the license to the floor where the apparatus C exists, the location is also selectable. Information can be acquired by enabling a user to input LOCATION as an initial setup item of the apparatus.

Referring to FIG. 12, if the return destination of the license automatic return setup is “CONNECTION APPARATUS INFORMATION REFERRING TYPE, and LOCATION”, the move destination may be set “9th fl.” to make the license return to the apparatus B.

FREQUENCY OF USING CORRESPONDING FUNCTION (COUNTER VALUE) is selectable since it is possible to consider that it is better to return the license to an apparatus having a high frequency of using the corresponding function. Because the counter values of the functions are managed by the apparatus, the information can be acquired.

Referring to FIG. 12, if the return destination of the license automatic return setup is “CONNECTION APPARATUS INFORMATION REFERRING TYPE and FREQUENCY OF USING CORRESPONDING FUNCTION”, the license is returned to an apparatus B having the frequency of using corresponding function (the counter value), or the license is returned to the apparatus C having the highest frequency of using corresponding function (the greatest counter value).

The number of the registered users can be selected because the frequency of using the functions may increase as the number of the users are large. In the apparatuses, the number of the registered users may be acquired from an address book.

Referring to FIG. 12, when the return destination of the license automatic return setup is “CONNECTION APPARATUS INFORMATION REFERRING TYPE and NUMBER OF REGISTERED USERS”, the license is moved to the apparatus A having the largest number of the registered users.

Referring to FIG. 12, “LICENSE AUTOMATIC RETURN IS REQUESTED FOR:” can be set up as the information of determining the license return destination. As to “LICENSE AUTOMATIC RETURN IS REQUESTED FOR:” the license may be basically returned from the other apparatus. However, there is a case where the corresponding license cannot be moved or the license movement is requested to be avoided in reference of the setup information of license holding apparatuses. Because it is difficult to know when the license is acquired (moved), depending on a timing, the corresponding license may be moved between the apparatuses to set the license automatic return setup (the data referring type), the license automatic return setup may be set to determine a priority of license automatic returns. With an initial setup or an item of setting up the license move management information for a function of reserving the automatic movement, the information can be acquired.

Referring to FIG. 12, if the license moved between the apparatuses in FIG. 12 is “MARKING FUNCTION” and the return destination of LICENSE AUTOMATIC RETURN SETUP is CONNECTION APPARATUS DATA REFERRING TYPE and LICENSE AUTOMATIC RETURN is desired, the license is returned to the apparatus B in which the desired setup is done.

In the above, the return process based on the license automatic return setup has been described. However, if a request for the license movement is received from the other apparatus before the timing of the license automatic return, the license may be moved to the apparatus of the request source by giving a priority to the license move request from the other apparatus. On the contrary, when the license move request is received from the other apparatus before the license automatic return timing, the automatic return setup of the own apparatus is given a priority and the license move request from the other apparatus is cancelled. It is also possible to previously select whether the license move request or the automatic return setup is given a priority.

### (License Structure Restoration)

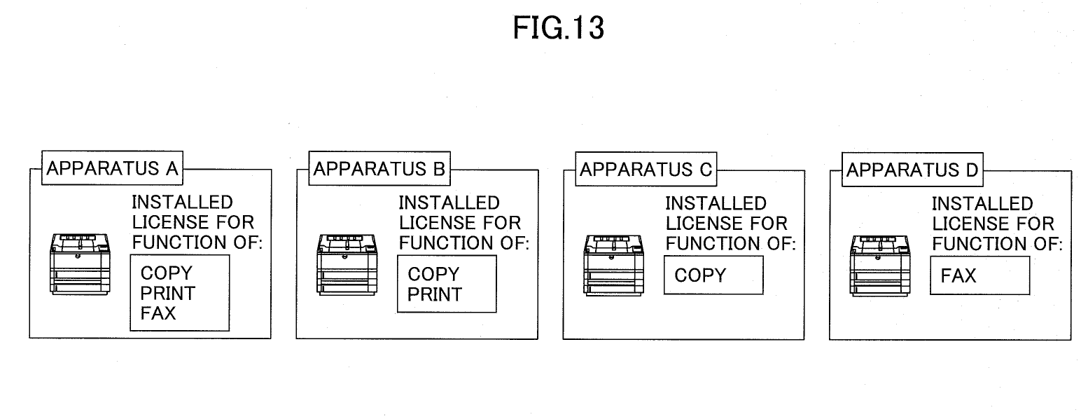

FIG. 13 illustrates original licenses installed in apparatuses as an example. An apparatus A has licenses for functions of copy, print, and fax. An apparatus B has licenses for functions of copy and print. An apparatus C has a license for a function of copy. An apparatus D has a license for a function of FAX.

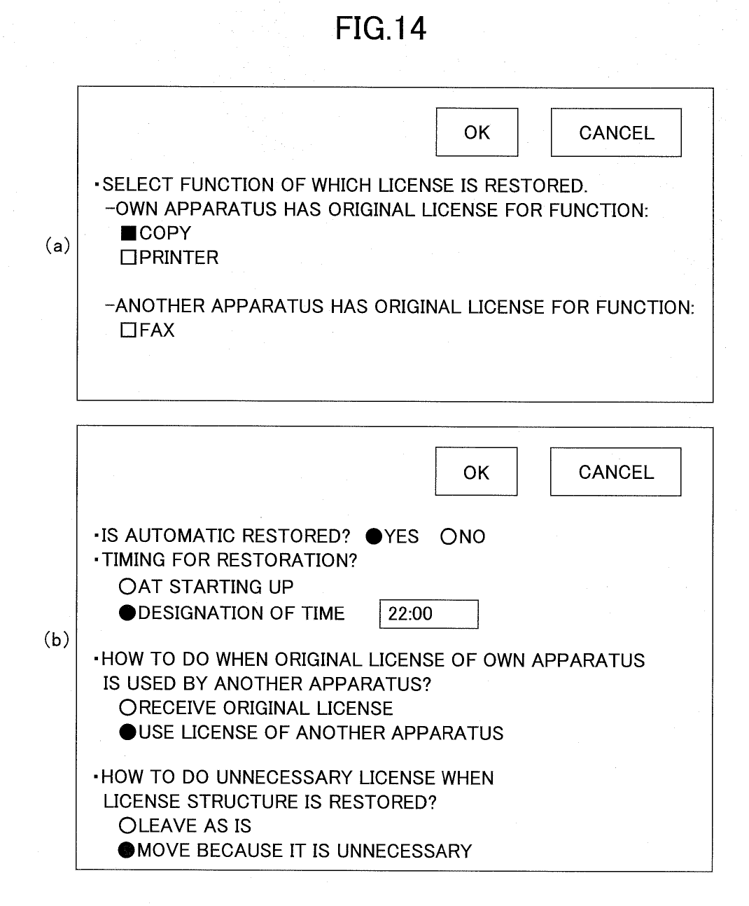

FIG. 14 illustrates examples of setup screens of the license structure management information which are set up in the apparatus B of FIG. 13.

At first, referring to (a) of FIG. 14, the function corresponding to a license to be restored is selected. The functions to be selected are not only functions of the apparatus having an original license (e.g., copy and print of the apparatus B) but also the function (e.g., fax of the apparatuses A and D) of the other apparatuses.

When the other apparatus is the apparatus having the original license, the license of the apparatus having the original license may be selected if the license has been used at least once by the own apparatus. Instead of this, all the licenses held by the other apparatuses may be searched and set to be selectable.

When a user selects the function in the own apparatus and pushes a button of OK, a screen illustrated in (b) of FIG. 14 is displayed.

The user can select whether the automatic restoration is carried out; a restoration timing; what action is taken when the original license of the apparatus of the original license is being used; and how to handle a license being unnecessary to restore the license structure.

The setup information is held as the license structure management information illustrated in FIG. 3.

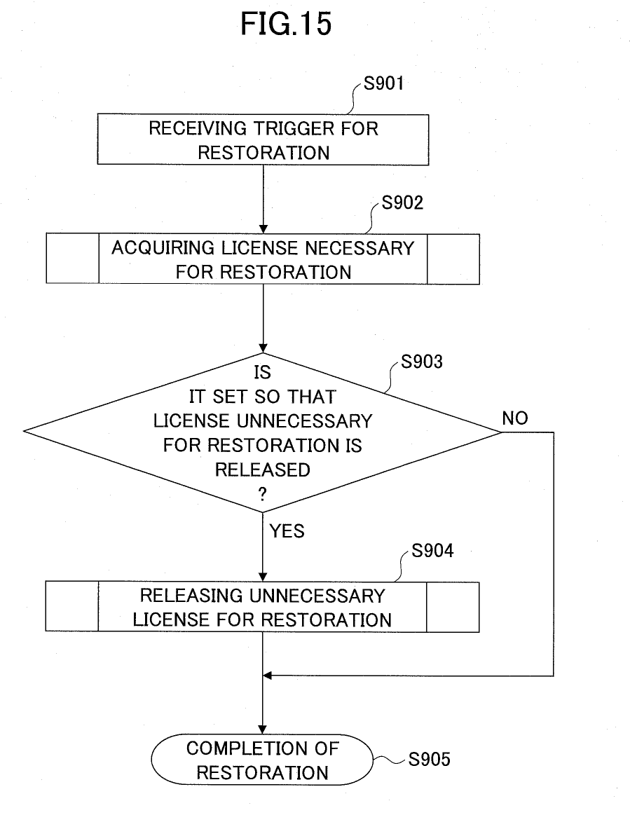

FIG. 15 is a flowchart illustrating an example process of a license structure restoration.

Referring to FIG. 15, the process is started by receiving a trigger for the restoration in step S901. The trigger for the restoration is a report of arrival of timings such as a clock time and a start-up of the automatic restoration determined by the license structure management unit 114, a report to the license structure management unit 114 caused by an user's operation (sending a restoration request by the user). In case of the user's operation, the restoration of the license structure can be done of a timing requested by the user.

Next, in step S902, the license necessary for the restoration is acquired. Said differently, it is confirmed whether the license necessary for restoring the license structure which is set by the license structure management information exists in the own apparatus. If the necessary license does not exist, the license is acquired from the other apparatus. A detailed description of this is given later.

In step S903, it is determined whether the license unnecessary for the restoration is released (whether a license other than the licenses stored as the license structure management information illustrated in FIG. 3 is UNNECESSARY).

When it is not set up such that the license unnecessary for the restoration is released, the process ends in step S905.

When it is set up so as to release the license unnecessary for the restoration, the license unnecessary for the restoration is released. Said differently, the unnecessary license is moved to the other apparatus. A detailed description of this is given later. By releasing the license unnecessary for the restoration, only the license declared to be necessary by the user is left in the apparatus. In step S905, the process is completed.

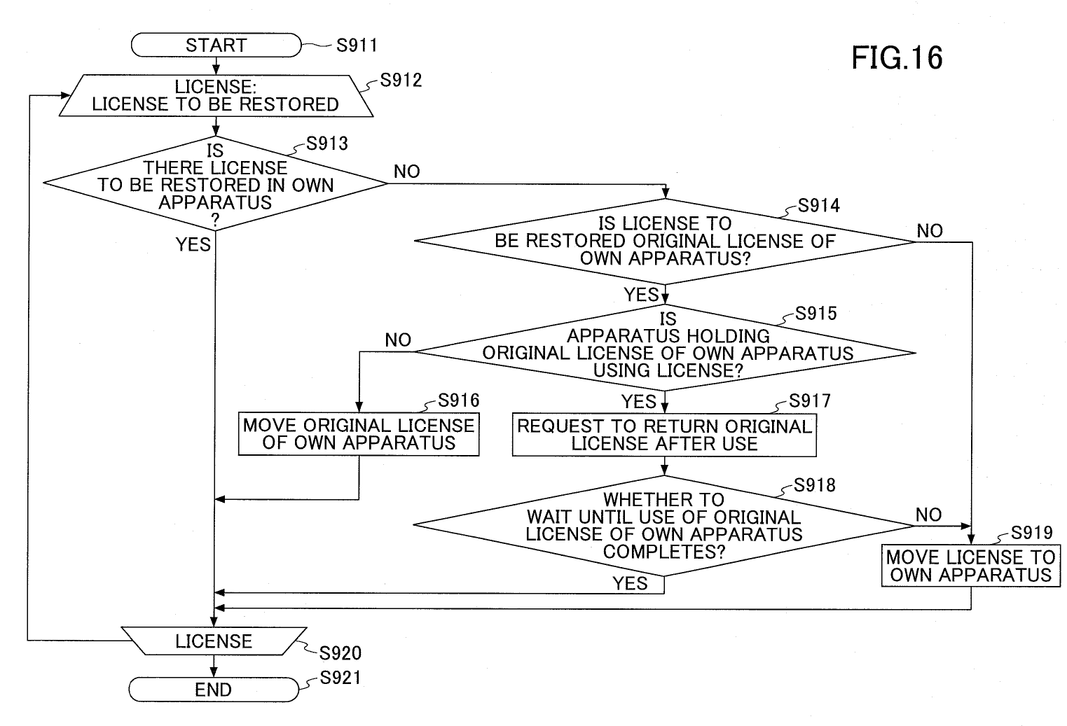

FIG. 16 is a flowchart illustrating an example process (step S902 of FIG. 15) of acquiring the license necessary for the restoration.

Referring to FIG. 16, after the process is started in step S911, one of the licenses to be restored which is set in the license structure management information is specified. Then the process of step S913 is carried out.

Referring to step S913, it is confirmed whether the license to be restored exists in the own apparatus. If the license exists in the own apparatus, the process returns from step S920 to step S912. If the license does not exist in the own apparatus, the process returns to step S914.

In step S914, it is confirmed whether the license to be restored is the original license of the own apparatus. If the license to be restored is the original license of the own apparatus, the process goes to the process of step S915. If the license to be restored is not the original license of the own apparatus, the process goes to the process of step S919.

In step S915, it is confirmed whether the license to be restored is being used in another apparatus. If the license to be restored is being used in the other apparatus, the process goes to step S917. If the license to be restored is not being used in the other apparatus, the process goes to step S916.

In step S916, the license to be restored is moved to the own apparatus. Thereafter, the process returns from step S920 to step S912 so as to process the next license. The license is processed in a manner similar to the above process carried out by the license move management unit 112.

In step S917, it is requested to the corresponding apparatus when the currently used license is completed. Then, the process goes to the process of step S918.

In step S918, it is confirmed by the setup of the license structure management information (see FIG. 3) whether the license currently being used by the other apparatus is restored after the use of the license is completed or the license is acquired from the other apparatus. If the license is acquired from the other apparatus, the process goes to step S919. If the process waits for the end of the use, the process returns from step S920 to step S912. Then, the next process is done.

In step S919, the necessary license is acquired from the other apparatus. Then, the process returns from step S920 to step S912 to process the next license. The license is processed in a manner similar to the above process carried out by the license move management unit 112.

If the processes are done for all the licenses, the process ends in step S921.

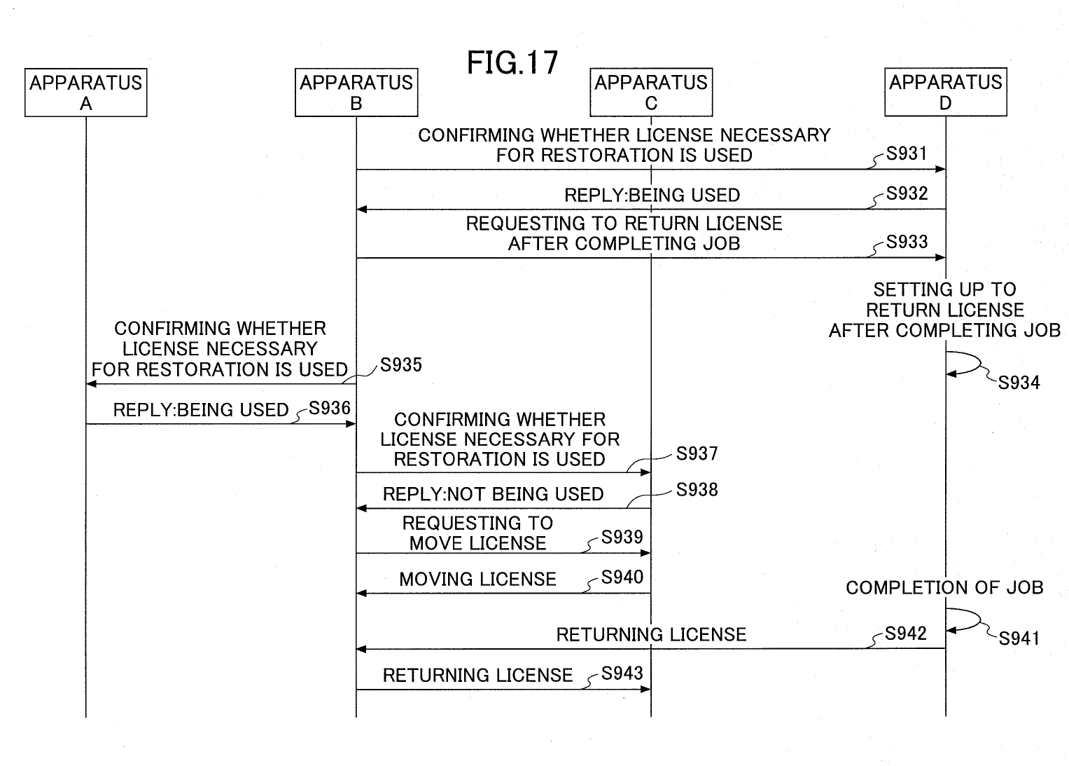

FIG. 17 is a sequence chart illustrating an example process when a license necessary for the restoration is being used. The process illustrated in FIG. 17 includes the processes illustrated in FIG. 16 and other processes.

Referring to FIG. 17, the apparatus B confirms whether the license necessary for the restoration is being used by the apparatus D by querying the apparatus D. If the apparatus B receives a reply that the necessary license is being used from the apparatus D, the apparatus B requests the apparatus D to return the license after the completion of the job in step S933. The apparatus D internally sets up in step S934 to return the license after the completion of the job in step S934.

When it is set up to receive the function being used from the other apparatus, the apparatus B confirms with the apparatus A whether the license necessary for the restoration is being used in step S935. If there is a reply from the apparatus A that the apparatus A is using the license in step S936, the license is not requested to be returned because the license is not the original license of the apparatus B.

In step S937, the apparatus B queries the apparatus C to confirm whether the license necessary for the restoration is being used. If the apparatus B receives a reply that the apparatus C does not use the license in step S938, the apparatus B requests the apparatus C to move the license. In step S940, the license is moved from the apparatus C.

Thereafter, in step S941, the corresponding job of the apparatus D is completed and the license is returned from the apparatus D to the apparatus B. The apparatus B returns the borrowed license to the apparatus C in step S943.

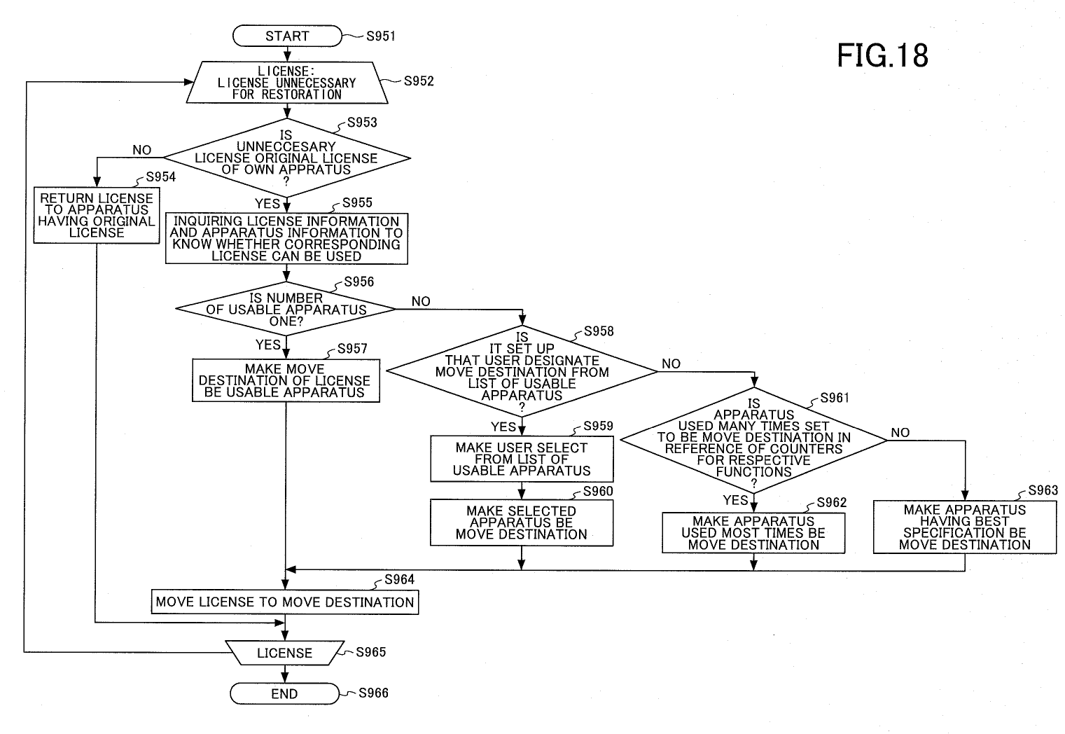

FIG. 18 is a flowchart illustrating an example process (step S904 of FIG. 15) of releasing the license unnecessary for the restoration.

Referring to FIG. 18, after the process is started in step S951, one of the license to be restored which is set in the license structure management information is specified in step S952. Then the process of step S953 is carried out.

In step S953, it is confirmed whether the license to be restored is the original license of the own apparatus. If the license to be restored is the original license of the own apparatus in YES of step S953, the process goes to the process of step S955. If the license to be restored is not the original license of the own apparatus in NO of step S953, the process goes to the process of step S954.

In step S954, the license is returned to the apparatus having the original license. Thereafter, the process returns from step S965 to step S952 and the next license is processed.

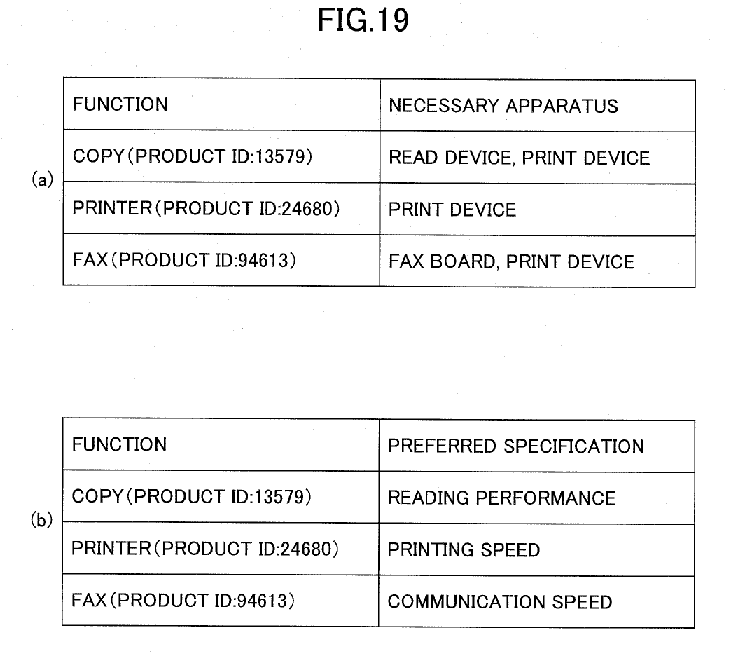

In step S955, the own apparatus inquires whether the corresponding license is usable by the other apparatus of the license file management unit 111 and the apparatus management unit 113 of the other apparatus in order to know whether the corresponding license is used by the other apparatus. Then, the process goes to step S956. In the inquiry, the own apparatus inquires whether a license having the function of the license to be returned is held of the license file management unit 111 and inquires whether the apparatus necessary to use the function of the license to be returned is installed in the other apparatus of the apparatus management unit 113. The apparatuses hold information indicative of what are devices necessary for using functions relative to the functions as illustrated in (a) of FIG. 19. Based on the information, the own apparatus inquires of the apparatus management unit 113 whether the function can be used by the other apparatus.

Referring to FIG. 18, it is checked whether the number of usable apparatuses is one in step S956. If the number of the usable apparatuses is one, the process goes to step S957. If the number of the usable apparatuses is not one, the process goes to step S958.

In step S957, the usable apparatus is set as the move destination of the license. Then, the process goes to step S964.

In step S958, it is confirmed whether the apparatus of the move destination is manually selectable by the user among the plural apparatuses which can respectively use plural licenses. If the apparatus of the move destination is manually selectable in YES of step S958, the process goes to step S959. If the apparatus of the move destination is not manually selectable in NO of step S958, the process goes to step S961.

In step S959, a list of usable apparatuses is presented to the user so that the user selects the apparatus to which the license is moved. Then, the process moves to step S960.

In step S960, the apparatus selected by the user is set as the move destination. Then, the process goes to step S964.

In step S961, it is confirmed whether the apparatus of the move destination is determined in reference of the values of counters for the functions of the apparatuses. If the apparatus of the move destination is set by referring to the counters for the functions, the process goes to step S962. If the apparatus of the move destination is not set by referring to the counters for the functions, the process goes to step S963.

In step S962, the apparatus which can use the license and has the greatest counter value as most frequently used is set as the apparatus of the move destination. Then, the process goes to step S964.

In step S963, the specifications of the apparatuses are checked. The apparatus having the highest specification is set as the move destination. Then the process goes to step S964. The apparatuses having information indicative of which specifications have priority are held for the functions as illustrated in (b) of FIG. 19. Based on the information, the own apparatus inquires of the apparatus management unit 113 of the other apparatuses. Preferred specifications are determined by default as illustrated in (b) of FIG. 19. However, the user can change the preferred specifications.

Referring back to FIG. 18, the license is moved to the apparatus of the move destination in step S964. The next license is processed by returning from step S965 to step S952.

When it is determined that all the licenses are processed in step S965, the process ends in step S966.

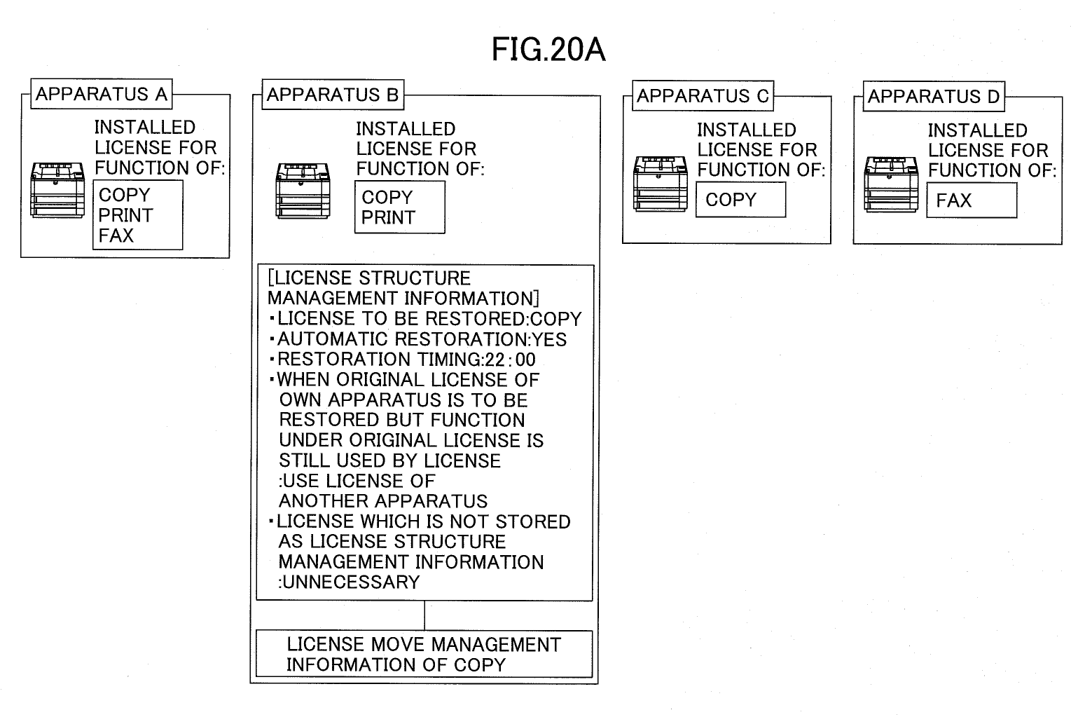

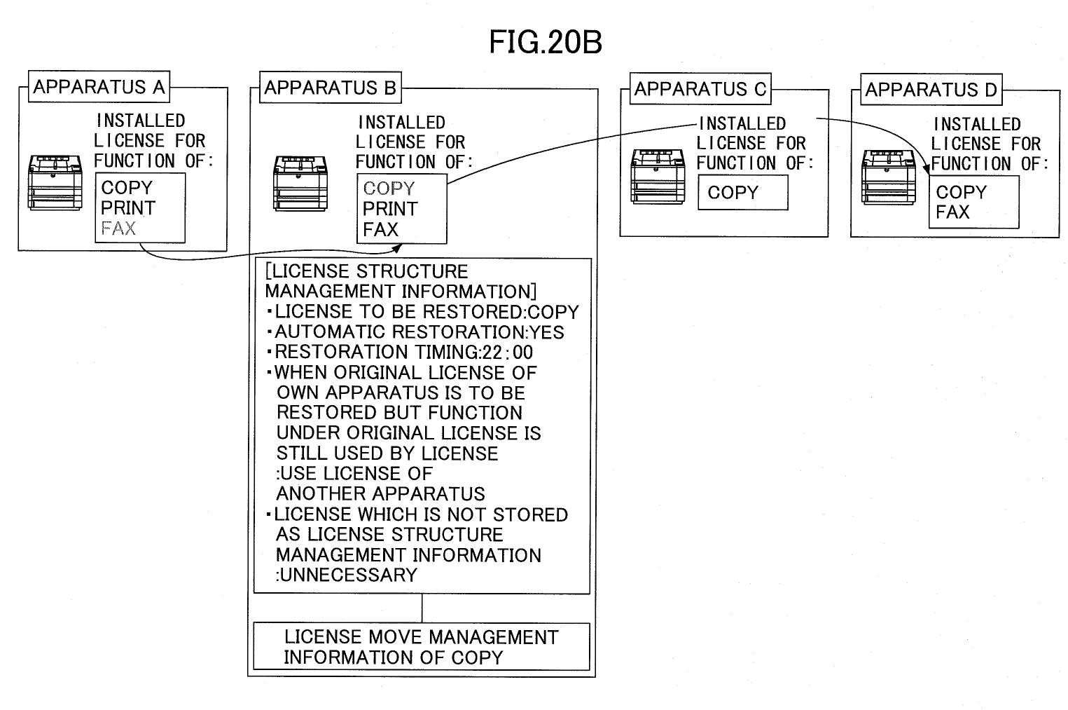

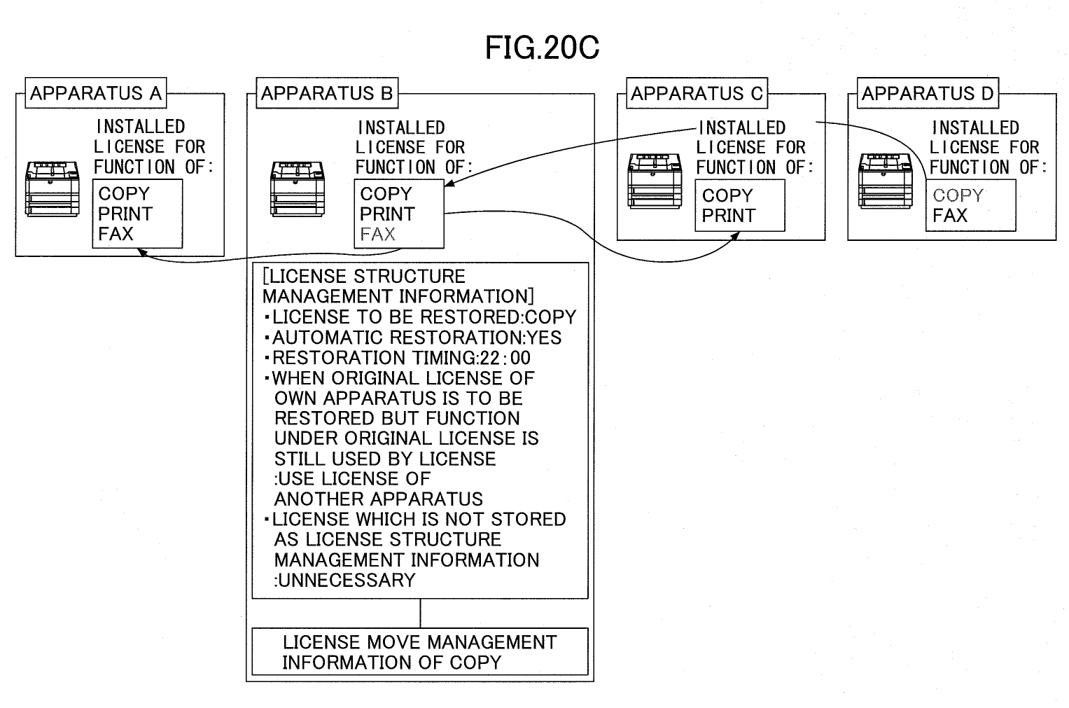

FIG. 20A to FIG. 20C illustrate an example license structure restoration based on the license structure management information. The license restoration is moved along FIG. 20A to FIG. 20C.

FIG. 20A illustrates an initial state (the apparatus having the original license). The apparatus A has licenses for functions of copy, print, and fax. The apparatus B has licenses for functions of copy and print. The apparatus C has a license for a function of copy. The apparatus D has a license for a function of FAX. Further, the apparatuses A to D can have license structure management information. For easy explanation, only the apparatus B has the license structure management information in FIG. 20A to FIG. 20C.

The license structure management information of the apparatus B is set as follows: the license to be restored: COPY; automatic restoration: YES; the restoration timing: 22:00;when the original license of the own apparatus is to be restored but function under the original license is still used by the licensee: use the license of another apparatus; and a license which is not stored as license structure management information: unnecessary.

Referring to FIG. 20B, in conformity with an ordinary move request, the license of the function of FAX is moved from the apparatus A to enable the apparatus B to use the function of FAX, and a license of the function of COPY is moved from the apparatus B to enable the apparatus D to use the function of COPY.

Referring to FIG. 20C, the licenses are restored upon the arrival of the restoration timing of the license structure management information of the apparatus B. The license existing in the apparatus B in FIG. 20B is for PRINT and FAX and the function of COPY to be restored does not exist. Further, since the licenses other than the function of COPY is unnecessary, the functions of PRINT and FAX are unnecessitated. Therefore, the license necessary for the restoration is only for the function of COPY, and the license unnecessary for the restoration is for the functions of PRINT and FAX.

The license unnecessary for the restoration is:

a license moved from the other apparatus; and
an original license of the own apparatus which is not contained in the license structure management information.

Because the license of PRINT is the original license of the apparatus B, the license of PRINT corresponds to the latter of the license unnecessary for the restoration. Because the license of FAX is moved from the apparatus A, the license of FAX corresponds to the former of the license unnecessary for the restoration.

The license of the function of COPY necessary for the restoration is returned from the apparatus D which holds the original license of the function of COPY of the own apparatus B. If the function is being used by the apparatus D, it is requested to the apparatus D to return the license after the apparatus completes the job. Thereafter, the license held by the other apparatuses such as the apparatuses A or C is moved to the apparatus B and used until the license is returned from the apparatus D.

The license of the function of FAX which has been moved from the apparatus A is returned to the apparatus having original license being the apparatus A based on the license move management information.

Although the own apparatus B of the license of the function of PRINT is the apparatus having original license, because the function of PRINT is not contained in the license structure management information, the license of the function of PRINT is moved to the other apparatus C . The apparatus C of the move destination inquires of the license file management units 111 and the apparatus management units 113 of the apparatuses and determines whether the license of the function of PRINT is received by the apparatus C in reference to the existence of the license to be moved and the license can be used in consideration to the hardware and software structure. When there are plural apparatuses to which the license can be moved, the apparatus of the move destination is selected. In the selection, the apparatus can be moved to the apparatus having a higher performance or to the apparatus having more frequent times of using the function. Thus, the apparatus of the move destination is automatically determined. As the method of not automatically determining the apparatus of the move destination, a list of the apparatuses to which the license is movable is displayed so that the user can select the apparatus of the move destination. The license is finally moved to the apparatus C.

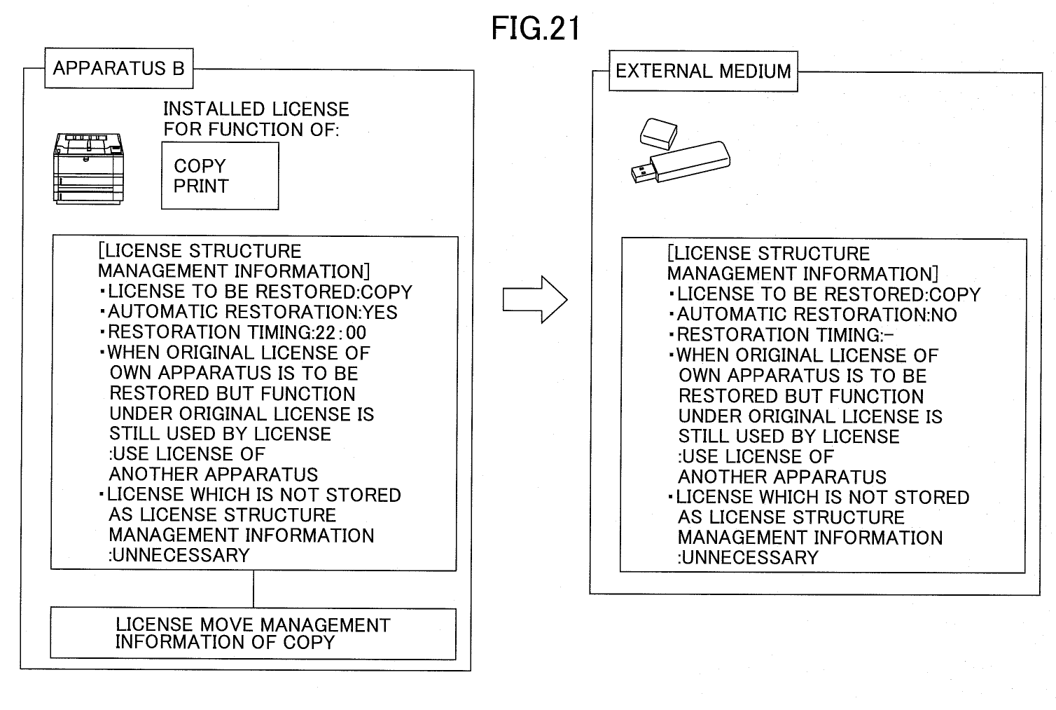

FIG. 21 illustrates an example export of license structure management information to an external medium.

The license structure management information is not only stored in the apparatus but also in an external medium such as a flash memory. In this case, the restoration timing is not determined.

If the external medium, in which the license structure management information is stored, is inserted in the apparatus, a trigger for restoring the license structure of an apparatus, to which the external medium is installed, to the license structure stored in the external medium is sent to the license structure management unit 114. The license structure restoration is done in a manner similar to the above process. Because the external medium can be installed in various apparatuses including the exported apparatus, the restoration of the license can be done in the various apparatuses based on the license structure management information stored in the external medium.

As described, as a measure of moving the function or license between the apparatuses, in addition to the existence of the license file provided by the license management system, the information of whether the license exists is newly managed and the license automatic return is provided. Therefore, the installed software license can be easily moved to the other apparatus without using a license key and without applying a load on the user. After the license is moved, the license is automatically returned to a desirable apparatus to easily restore the license structure desired by the user.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

This patent application is based on Japanese Priority Patent Application No. 2010-184853 filed on Aug. 20, 2010, the entire contents of which are hereby incorporated herein by reference.

What is claimed is:

1. An information processing apparatus comprising:
an installing part configured to install a function by downloading installing data of the function from an outside;
a license file acquiring part configured to acquire a license file for activating the function from outside the information processing apparatus;
a license managing part configured to manage existence of a license for the function regardless of existence of the license file;
a license moving and updating part configured to move the license to or from another apparatus and update existence of the license of the function;
a license returning part configured to cause the moved license to be returned based on an automatic return condition to a predetermined apparatus; and
a license holding part configured to hold a predetermined license structure of the information processing apparatus set up by a user to cause the license to be moved in conformity with the predetermined license structure.

2. The information processing apparatus according to claim 1,
wherein the license included in the predetermined license structure is selectable from at least an original license of the information processing apparatus and other licenses held by other apparatuses.

3. The information processing apparatus according to claim 1,
wherein a timing of moving the license in conformity with the predetermined license structure is determined as a clock time or a start-up of the information processing apparatus.

4. The information processing apparatus according to claim 1,
wherein if the original license is being used by one of the other apparatus and returned to the information processing apparatus, the license moving and updating part requests to move the original license and moves the original license after the use of the original license by the one of the other apparatuses is completed.

5. The information processing apparatus according to claim 4,
wherein the information processing apparatus uses a license corresponding to the original license and held by any one of the other apparatuses until the original license is moved to the information processing apparatus.

6. The information processing apparatus according to claim 5,
wherein when the license moving and updating part moves the original license after the use of the original license by the one of the other apparatuses is completed, the license corresponding to the original license is returned to the any one of the other apparatuses.

7. The information processing apparatus according to claim 1,
wherein when the license holding part causes the license to be moved in conformity with the predetermined license structure of the information processing apparatus, the license which is not contained in the predetermined license structure and held by the information processing apparatus is released to the other apparatuses.

8. The information processing apparatus according to claim 7,
wherein a destination of releasing the license being the original license of the information processing apparatus is selected from any one of the other apparatuses which has a device necessary for using the function corresponding to the license to be moved.

9. The information processing apparatus according to claim 8,
wherein in selecting the destination of releasing the license, specifications of the functions of the any one of the other apparatuses are compared to determine the any one of the other apparatuses having the highest specification as the destination of releasing the license.

10. The information processing apparatus according to claim 8,
wherein in selecting the destination of releasing the license, counters of using the functions in the any one of the other apparatuses are compared to determine the any one of the other apparatuses having a highest value of the counters as the destination of releasing the license.

11. An information processing method carried out in an information processing apparatus, the information processing method comprising:
installing a function by downloading installing data of the function from outside the information processing apparatus;
acquiring a license file for activating the function from outside the information processing apparatus;
managing existence of a license for the function regardless of existence of the license file;
moving the license to or from another apparatus and updating existence of the license of the function;
causing the moved license to be returned based on an automatic return condition to a predetermined apparatus; and
holding a predetermined license structure of the information processing apparatus set up by a user to cause the license to be moved in conformity with the predetermined license structure.

12. The information processing method according to claim 11,
wherein the license included in the predetermined license structure is selectable from at least an original license of the information processing apparatus and other licenses held by other apparatuses.

13. The information processing method according to claim 11,
wherein a timing of moving the license in conformity with the predetermined license structure is determined as a clock time or a start-up of the information processing apparatus.

14. The information processing method according to claim 11,
wherein if the original license is being used by one of the other apparatus and returned to the information processing apparatus, the moving requests to move the original license and moves the original license after the use of the original license by the one of the other apparatuses is completed.

15. The information processing method according to claim 14,
wherein the information processing apparatus uses a license corresponding to the original license and held by any one of the other apparatuses until the original license is moved to the information processing apparatus.

16. The information processing method according to claim 15,
wherein when the moving moves the original license after the use of the original license by the one of the other apparatuses is finished, the license corresponding to the original license is returned to the any one of the other apparatuses.

17. The information processing method according to claim 11,
wherein when the holding causes the license to be moved in conformity with the predetermined license structure of the information processing apparatus, the license which is not contained in the predetermined license structure and held by the information processing apparatus is released to the other apparatuses.

18. The information processing method according to claim 17,
wherein a destination of releasing the license being the original license of the information processing apparatus is selected from any one of the other apparatuses which has a device necessary for using the function corresponding to the license to be moved.

19. The information processing method according to claim 18,
wherein in selecting the destination of releasing the license, specifications of the functions of the any one of the other apparatuses are compared to determine the any one of the other apparatuses having the highest specification as the destination of releasing the license.

20. The information processing method according to claim 18,
wherein in selecting the destination of releasing the license, counters of using the functions in the any one of the other apparatuses are compared to determine the any one of the other apparatuses having a highest value of the counters as the destination of releasing the license.
